(19) United States
(12) Patent Application Publication
(10) Pub. No.: US 2006/0194029 A1
(43) Pub. Date: Aug. 31, 2006

(54) Ink composition, inkjet recording method using the same, and printed material

(75) Inventor: Shigetomo Tsujihata, Shizuoka-ken (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/360,498

(22) Filed: Feb. 24, 2006

(30) Foreign Application Priority Data
Feb. 28, 2005 (JP) 2005-55015

(51) Int. Cl. C08L 51/00; B41M 5/00

(52) U.S. Cl. 428/195.1; 525/70

(57) ABSTRACT

An ink composition containing (a) a polymerizable compound, (b) a pigment, and (c) a graft polymer having, as a polymerization unit, a polymerizable oligomer having an ethylenically unsaturated double bond at least at a terminal thereof. The graft polymer (c) preferably contains, as a polymerization unit, a polymerizable oligomer having a number-average molecular weight of 1000 to 20000 and having a (meth)acryloyl group at a terminal thereof.

### CROSS-REFERENCE TO RELATED APPLICATION

This application claims priority under 35 USC 119 from Japanese patent Application No. 2005-055015, the disclosure of which is incorporated by reference herein.

### BACKGROUND OF THE INVENTION

1. Field of the Invention

The present invention relates to an ink composition used preferably for inkjet recording, an inkjet recording method, and a printed material obtained by using the same. The invention relates in particular to an ink composition suitable for inkjet recording, which is excellent in pigment dispersibility and superior in coloring properties and can be cured by irradiation with active radiation to form high-quality images, and an inkjet recording method and a printed material using the same.

2. Description of the Related Art

Electrophotographic systems, sublimation-type and melting-type thermal transfer systems, and inkjet systems are image recording methods of forming an image on a recording medium such as paper based on image data signals. In particular, inkjet systems are applicable to an inexpensive apparatus, and perform direct image formation on a recording medium by ejecting ink only to image areas where ink deposition is necessary; therefore, inkjet systems use ink effectively, thus reducing the running cost. Further, inkjet systems generate less noise and are superior image recording systems.

Inkjet systems enable printing on recording media that do not absorb water, such as plastic sheets and metallic plates, as well as on paper. In inkjet systems, it is an important target to achieve higher printing speed and higher printing quality. Therefore, the time liquid droplets take to dry and cure after printing has significant influence on the sharpness of the image.

In one inkjet system, an inkjet recording ink that can be cured by irradiation with active radiation is used. According to this system, sharp images can be formed by curing ink droplets by irradiation with radiation just after printing.

In order to form highly accurate images with excellent coloring properties, such a curable ink composition is required to have high pigment dispersibility and stability over time. Reduction in the pigment size is necessary for imparting clear tone and high tinting strength to the ink composition. In particular, ejected droplets of the inkjet ink exert a significant influence on the sharpness of images; therefore, the ejection quantity of the ink droplets needs to be small and the size of the pigment particles contained in the ink has to be smaller than the thickness of the film formed by curing of the ink. However, when the size of the pigment particles is reduced so as to achieve higher tinting strength, the fine particles are hard to disperse, thus easily forming aggregates. Another problem is created in that the viscosity of the ink composition is increased by the addition of a dispersant. The formation of the pigment aggregates and the increase in the viscosity of the ink composition both adversely affect the ink ejection property, and such an ink composition is not preferred.

When an ink composition is used in inkjet recording, the ink composition is contained in a cartridge. The ink composition in the cartridge is heated at ejection and cooled at a non-ejection time or at storage; in this way, the ink composition undergoes repeated temperature changes (heating-cooling). This temperature changes also adversely affect the pigment dispersibility, and the pigment dispersibility is deteriorated with time, whereby problems are created in that thickening and aggregation easily occurs.

Accordingly, there is a demand for an ink composition having sufficient fluidity and excellent stability of the pigment dispersion over time, in which fine pigment particles are dispersed stably. Various proposals have been made concerning dispersants for achieving stable pigment dispersion liquids.

For improving compatibility with the pigment, an ink composition using a pigment derivative as a dispersant (see e.g. Japanese Patent Application Laid-Open (JP-A) No. 2003-119414) and an ink composition that uses a polymer having a basic group as a dispersant for a specific pigment such as a phthalocyanine-based or quinacridone-based pigment (see e.g. JP-A No. 2003-321628) have been proposed. However, since these dispersants are selected in relation to specific pigments, they have a problem of lack of versatility.

An ink composition has been proposed (see e.g. JP-A No. 2004-131589) which is free of organic solvent and contains a dispersant (e.g., a special polymer compound, poly(ethyleneimine)-poly(12-hydroxystearic acid) graft polymer) and a specific monomer that dissolves the dispersant.

In this ink composition, the pigment dispersibility is actually improved owing to the function of the dispersant. However, the size of the pigment used in the ink composition is not sufficiently small, and there is a room for improvement of dispersibility of finer pigment particles. Further, the ink composition also has a problem in that the dispersion stability upon long-term storage or upon repeated temperature changes is still insufficient.

### SUMMARY OF THE INVENTION

The present invention has been made in consideration of the problems of the conventional techniques.

After intensive study, the inventor has found that an ink composition excellent in pigment dispersibility can be obtained by using, as a pigment dispersant, a graft polymer having a polymerization unit consisting of a specific polymerizable oligomer. The ink composition is excellent in the stability of the pigment dispersion, and effectively suppresses the reduction of the dispersion stability even after long-term storage or after repeated temperature changes. Based on the finding, the present invention has been completed.

The invention provides an ink composition that contains (a) a polymerizable compound, (b) a pigment, and (c) a graft polymer having, as a polymerization unit, a polymerizable oligomer having an ethylenically unsaturated double bond at least at a terminal thereof. The polymerizable oligomer may have a (meth)acryloyl group at a terminal thereof. The polymerizable oligomer may have a number-average molecular weight of 1000 to 20000. The polymerizable oligomer may be a homopolymer or copolymer of one or more monomers selected from alkyl(meth)acrylates, styrene, and derivatives thereof. The graft polymer may further have, as a polymerization unit, a monomer having a nitrogen-containing group and an ethylenically unsaturated double bond. The monomer having a nitrogen-containing group and an ethylenically unsaturated double bond may be represented by the following formula (I):

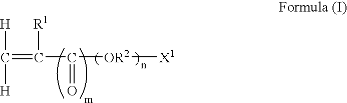

In formula (I), R¹ represents a hydrogen atom or a methyl group; R² represents a C1 to C12 alkylene group; X¹ represents —N(R³)(R⁴), —R⁵—N(R⁶)(R⁷), or a basic nitrogen-containing heterocyclic group; R³, R⁴, R⁶ and R⁷ each independently represent a hydrogen atom, a C1 to C18 alkyl group, or a C6 to C18 aryl group; R⁵ represents a C1 to C12 alkylene group; and m and n each independently represent 1 or 0.

The ink composition may further contain (d) a photopolymerization initiator. The polymerizable compound (a) may be a radical polymerizable compound, and the photopolymerization initiator (d) may be a photoradical generator. The polymerizable compound (a) may be a cation-polymerizable compound, and the photopolymerization initiator (d) may be a photoacid generator. The ink composition may be an ink composition for inkjet recording.

The invention further provides an inkjet recording method comprising depositing the above ink composition on a recording medium with an inkjet printer, and curing the deposited ink composition by irradiation with active radiation.

The invention also provides a printed matter produced by depositing the above ink composition on a recording medium with an inkjet printer and curing the ink composition by irradiation with active radiation.

The ink composition of the invention can be used in usual printing to form a sharp image with excellent coloring property, thus giving a high-quality printed material. The ink composition of the invention can be advantageously used also in the production of resists, color filters, and optical disks, and is useful also as an optical molding material.

When the ink composition of the invention is applied to the inkjet recording method, a high-quality image can be formed even on a non-absorptive recording medium directly based on digital data, and the ink composition of the invention can thus be used advantageously for the production of a printed material having a large area.

### DETAILED DESCRIPTION OF THE INVENTION

The ink composition of the present invention comprises (a) a polymerizable compound, (b) a pigment, and (c) a graft polymer having, as a polymerization unit, a polymerizable oligomer having an ethylenically unsaturated double bond at least at a terminal thereof.

The ink composition of the invention is cured by the function of the polymerizable compound (a) upon application of some energy. The ink composition preferably contains (d) a polymerization initiator and cures upon irradiation with active radiation. The active radiation is not particularly limited insofar as they can give energy for generating initiator species in the ink composition upon irradiation therewith. Examples thereof include α-rays, γ-rays, X-rays, UV rays, visible rays, electron beams etc., among which UV rays and electron beams are preferable from the viewpoint of the sensitivity at curing and availability of apparatus therefor. In particular, UV rays are preferable. Accordingly, the ink composition of the invention is preferably an ink composition curable by irradiation with UV rays as radiation.

Hereinafter, the respective components used in the ink composition of the invention are described sequentially.

(c) Graft Polymer Having, as a Polymerization Unit, a Polymerizable Oligomer Having an Ethylenically Unsaturated Double Bond at Least at a Terminal

First, the graft polymer having, as a polymerization unit, a polymerizable oligomer having an ethylenically unsaturated double bond at least at a terminal thereof (c) (hereinafter referred to as specific polymer (c) in some cases) used in the invention is described.

In the invention, a specific graft polymer is contained in the ink composition, and the graft polymer to be used has, as a polymerization unit, a polymerizable oligomer having an ethylenically unsaturated double bond at a terminal thereof. The polymerizable oligomer recited in the invention is a compound having a predetermined molecular weight, and is thus also called a macromonomer. By using such a macromonomer for forming a graft polymer, a polymer having a branch of a desired chain length (molecular weight) can be easily obtained, whereby the molecular design based on the functions can be easily carried out. In particular, the specific polymer (c) according to the invention can be favorably used as a pigment dispersant.

The polymerizable oligomer according to the invention contains a polymer chain moiety and a polymerizable functional group moiety at a terminal of the polymer chain. The polymerizable functional group moiety has an ethylenically unsaturated double bond. From the viewpoint of obtaining the desired graft polymer, the group having an ethylenically unsaturated double bond is preferably present at only one of the terminals of the polymer chain. The group having an ethylenically unsaturated double bond is preferably a (meth)acryloyl group or a vinyl group, particularly preferably a (meth)acryloyl group.

The polystyrene-equivalent number-average molecular weight (Mn) of the polymerizable oligomer is preferably in the range of 1000 to 20000, more preferably in the range of 2000 to 10000.

The polymer chain moiety is generally a homopolymer or copolymer of at least one monomer selected from alkyl(meth)acrylates, styrene and derivatives thereof, acrylonitrile, vinyl acetate, and butadiene. Among the above polymers, the polymer chain moiety is more preferably a homopolymer or copolymer of at least one monomer selected from alkyl(meth)acrylates and styrene and derivatives thereof.

The polymerizable oligomer is particularly preferably an oligomer represented by the following formula (1):

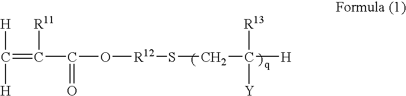

In formula (1), R¹¹ and R¹³ each independently represent a hydrogen atom or a methyl group; R¹² represents a C1 to C12 alkylene group (which may have a substituent (e.g., a hydroxyl group), and may be a combination of plural alkylene groups which are bonded to each other via an ester bond, an ether bond, an amide bond, or the like; R¹² is preferably a C2 to C8 alkylene group); Y represents a phenyl group, a phenyl group having a C1 to C4 alkyl group, or —COOR¹⁴ (R¹⁴ representing a C1 to C6 alkyl group, a phenyl group, or a C7 to C10 arylalkyl group); and q is 20 to 200. Y is preferably a phenyl group or —COOR¹⁴ in which R¹⁴ represents a C1 to C4 alkyl group).

Preferable examples of the polymerizable oligomer (macromonomer) include a polymer in which a (meth)acryloyl group is bound to one terminal of polystyrene, polymethyl(meth)acrylate, poly-n-butyl(meth)acrylate, or poly-i-butyl(meth)acrylate. Examples of commercially available polymerizable oligomers include a polystyrene oligomer having a methacryloyl group at one terminal (Mn=6000, trade name: AS-6, manufactured by Toagosei Co., Ltd.), a polymethyl methacrylate oligomer having a methacryloyl group at one terminal (Mn=6000, trade name: AA-6, manufactured by Toagosei Co., Ltd.), and a poly-n-butylacrylate oligomer having a methacryloyl group at one terminal (Mn=6000, trade name: AB-6, manufactured by Toagosei Co., Ltd.).

The pigment dispersant according to the invention is more preferably a graft copolymer with a monomer having a nitrogen-containing group and an ethylenically unsaturated double bond. The nitrogen-containing group is preferably basic, and the monomer is particularly preferably represented by formula (I):

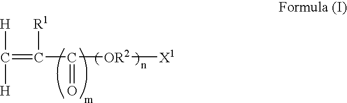

In formula (I), R¹ represents a hydrogen atom or a methyl group; R² represents a C1 to C12 alkylene group; X¹ represents —N(R³)(R⁴), —R⁵—N(R⁶)(R⁷), or a basic nitrogen-containing heterocyclic group; R³, R⁴, R⁶ and R⁷ each independently represent a hydrogen atom, a C1 to C18 alkyl group, or a C6 to C18 aryl group; R⁵ represents a C1 to C12 alkylene group; and m and n each independently represent 1 or 0.

In formula (I), R² represents a C1 to C12 alkylene group, preferably a C1 to C6 alkylene group, more preferably a C2 to C3 alkylene group. X¹ is —N(R³)(R⁴), —R⁵—N(R⁶)(R⁷), or a basic nitrogen-containing heterocyclic group.

R³and R⁴ in —N(R³)(R⁴) each independently represent a hydrogen atom, a C1 to C18 alkyl group, or a C6 to C18 aryl group. The alkyl group is preferably a C1 to C12 alkyl group, particularly preferably a C1 to C6 alkyl group. The aryl group is preferably a C6 to C12 aryl group, particularly preferably a C6 to C10 aryl group.

R⁵ in —R⁵—N(R⁶)(R⁷) represents a C1 to C12 alkylene group, preferably a C1 to C6 alkylene group, particularly preferably a C2 to C3 alkylene group. R⁶ and R⁷ each independently represent a hydrogen atom, a C1 to C18 alkyl group, or a C6 to C18 aryl group. The alkyl group is more preferably a C1 to C12 alkyl group, still more preferably a C1 to C6 alkyl group. The aryl group is preferably a C6 to C12 aryl group, more preferably C6 to C10 aryl group.

The basic nitrogen-containing heterocyclic group is preferably a pyridyl group (particularly 1-pyridyl group, 2-pyridyl group), a piperidino group (1-piperidino group), a pyrrolidyl group (particularly, 2-pyrrolidyl group), a pyrrolidino group, an imidazolino group, or a morpholino group (4-morpholino group), particularly preferably a pyridyl group or an imidazolino group.

The monomer represented by formula (1) is particularly preferably a compound represented by any one of the following formulae (I-2) to (I-4):

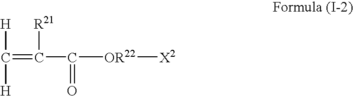

In formula (I-2), R²¹, R²² and X² have the same definitions as those of R¹, R² and X¹ in formula (I), respectively.

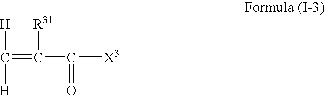

In formula (I-3), R³¹ has the same definition as that of R¹ in formula (I), and X³ has the same definition as that of X¹. X³ is preferably —N(R³³)(R³⁴) in which R³³ and R³⁴ have the same definitions as those of R³ and R⁴ respectively, or is preferably —R³⁵—N(R³⁶)(R³⁷) in which R³⁵, R³⁶ and R³⁷ have the same definitions as those of R⁵, R⁶ and R⁷ respectively.

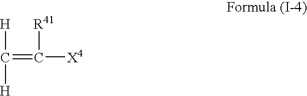

In formula (I-4), R⁴¹ has the same definition as that of R¹ in formula (I), and X⁴ represents a pyrrolidino group, a pyrrolidyl group, a pyridyl group, a piperidino group, an imidazolino group, or a morpholino group.

Preferable examples of compounds represented by formula (I) include: (meth)acrylates such as N,N-dimethylaminoethyl(meth)acrylate, N,N-dimethylaminopropyl(meth)acrylate, 1-(N,N-dimethylamino)-1,1-dimethylmethyl(meth)acrylate, N,N-dimethylaminohexyl(meth)acrylate, N,N-diethylaminoethyl(meth)acrylate, N,N-diisopropylaminoethyl(meth)acrylate, N,N-di-n-butylaminoethyl(meth)acrylate, N,N-di-i-butylaminoethyl(meth)acrylate, morpholinoethyl(meth)acrylate, piperidinoethyl(meth)acrylate, 1-pyrrolidinoethyl(meth)acrylate, N,N-methyl-2-pyrrolidylaminoethyl(meth)acrylate, and N-methylphenylaminoethyl(meth)acrylate; (meth)acrylamides such as dimethyl(meth)acrylamide, diethyl(meth)acrylamide, diisopropyl(meth)acrylamide, di-n-butyl(meth)acrylamide, di-i-butyl(meth)acrylamide, morpholino(meth)acrylamide, piperidino(meth)acrylamide, N-methyl-2-pyrrolidyl(meth)acrylamide, and N,N-methylphenyl(meth)acrylamide; aminoalkyl(meth)acrylamides such as 2-(N,N-dimethylamino)ethyl(meth)acrylamide, 2-(N,N-diethylamino)ethyl(meth)acrylamide, 3-(N,N-diethylamino)propyl(meth)acrylamide, 3-(N,N-dimethylamino)propyl(meth)acrylamide, 1-(N,N-dimethylamino)-1,1-dimethylmethyl(meth)acrylamide, and 6-(N,N-diethylamino)hexyl(meth)acrylamide; and vinyl pyridine.

In a preferable embodiment, the graft polymer used in the invention is a copolymer of the polymerizable oligomer, the monomer described above, and another monomer (additional monomer) copolymerizable therewith.

Examples of the additional monomer copolymerizable therewith include unsaturated carboxylic acids (e.g., (meth)acrylic acid, crotonic acid, itaconic acid, maleic acid, and fumaric acid), aromatic vinyl compounds (e.g., styrene, α-methylstyrene, and vinyl toluene), alkyl(meth)acrylates (e.g., methyl(meth)acrylate, ethyl(meth)acrylate, n-butyl(meth)acrylate, and i-butyl(meth)acrylate), alkylaryl(meth)acrylates (e.g., benzyl(meth)acrylate), glycidyl(meth)acrylate, vinyl carboxylates (e.g., vinyl acetate and vinyl propionate), vinyl cyanides (e.g., (meth)acrylonitrile and α-chloroacrylonitrile), and aliphatic conjugated dienes (e.g., 1,3-butadiene and isoprene). Among these compounds, unsaturated carboxylic acids, alkyl(meth)acrylates, alkylaryl(meth)acrylates, and vinyl carboxylate are preferable.

The specific polymer (c) according to the invention is a copolymer of the polymerizable oligomer (macromonomer) and the monomer having a nitrogen-containing group, or a copolymer of the polymerizable oligomer, the monomer having a nitrogen-containing group, and an additional monomer having an ethylenically unsaturated double bond copolymerizable therewith. In the copolymer, the quantity of the repeating units derived from the polymerizable oligomer is preferably in the range of 20 to 99 wt % (more preferably 20 to 80 wt %) based on the total quantity of the repeating units in the copolymer. The quantity of the repeating units derived from the monomer having a nitrogen-containing group is preferably in the range of 1 to 80 wt % (more preferably 5 to 60 wt %) based on the total quantity of the repeating units in the copolymer.

When the additional monomer copolymerizable therewith is used, the quantity of the repeating units derived from the additional monomer is preferably in the range of 5 to 70 wt % based on the total quantity of the repeating units in the copolymer. The weight-average molecular weight (Mw) of the copolymer is preferably in the range of 1000 to 200000, particularly preferably in the range of 10000 to 100000. This weight-average molecular weight is a polystyrene-equivalent weight-average molecular weight determined by gel permeation chromatography (in which tetrahydrofuran is used as the carrier).

Examples of the graft copolymer used preferably in the specific polymer (c) are shown below, but the invention is not limited thereto.
1) Copolymer of dimethylaminoethyl acrylate and polymethyl methacrylate having a methacryloyl group at a terminal thereof
2) Copolymer of diethylaminoethyl acrylate and polymethyl methacrylate having a methacryloyl group at a terminal thereof
3) Copolymer of di-n-butylaminoethyl acrylate and polymethyl methacrylate having a methacryloyl group at a terminal thereof
4) Copolymer of di-i-butylaminoethyl acrylate and polymethyl methacrylate having a methacryloyl group at a terminal thereof
5) Copolymer of dimethylaminoethyl acrylate and polystyrene having a methacryloyl group at a terminal thereof
6) Copolymer of dimethylaminoethyl acrylate, polymethyl methacrylate having a methacryloyl group at a terminal thereof, and benzyl methacrylate
7) Copolymer of diethylaminoethyl acrylate, polymethyl methacrylate having a methacryloyl group at a terminal thereof, and benzyl methacrylate
8) Copolymer of di-n-butylaminoethyl acrylate, polymethyl methacrylate having a methacryloyl group at a terminal thereof, and benzyl methacrylate
9) Copolymer of di-i-butylaminoethyl acrylate, polymethyl methacrylate having a methacryloyl group at a terminal thereof, and benzyl methacrylate
10) Copolymer of vinyl pyridine, polymethyl methacrylate having a methacryloyl group at a terminal thereof, and benzyl methacrylate
11) Copolymer of N,N-methyl-2-piperidylethyl acrylate, polymethyl methacrylate having a methacryloyl group at a terminal thereof, and benzyl methacrylate
12) Copolymer of 1-piperidinoethyl acrylate, polymethyl methacrylate having a methacryloyl group at a terminal thereof, and benzyl methacrylate
13) Copolymer of N,N-methylphenylaminoethyl acrylate, polymethyl methacrylate having a methacryloyl group at a terminal thereof, and benzyl methacrylate
14) Copolymer of 4-morpholinoethyl acrylate, polymethyl methacrylate having a methacryloyl group at a terminal thereof, and benzyl methacrylate
15) Copolymer of dimethylaminoethyl acrylate, polystyrene having a methacryloyl group at a terminal thereof, and benzyl methacrylate
16) Copolymer of dimethylaminoethyl acrylate, polystyrene having a methacryloyl group at a terminal thereof, and methyl methacrylate
17) Copolymer of dimethylaminoethyl acrylate, polystyrene having a methacryloyl group at a terminal thereof, and styrene
18) Copolymer of 3-(N,N-dimethylamino)propyl acrylamide and polymethyl methacrylate having a methacryloyl group at a terminal thereof
19) Copolymer of 3-(N,N-dimethylamino)propyl acrylamide and polystyrene having a methacryloyl group at a terminal thereof
20) Copolymer of 2-(N,N-dimethylamino)ethyl acrylamide and polymethyl methacrylate having a methacryloyl group at a terminal thereof
21) Copolymer of 2-(N,N-diethylamino)ethyl acrylamide and polymethyl methacrylate having a methacryloyl group at a terminal thereof
22) Copolymer of styrene and polymethyl methacrylate having a methacryloyl group at a terminal thereof
23) Copolymer of stearyl methacrylate and polymethyl methacrylate having a methacryloyl group at a terminal thereof

Such graft polymers can be obtained by radical polymerization, in a solvent, of the polymerizable oligomer and, optionally, the monomer having a nitrogen-containing group and/or other additional monomers. In this polymerization, a radical polymerization initiator is used in general. In addition to the initiator, a chain transfer agent (e.g., 2-mercaptoethanol and dodecyl mercaptan) may be further added for the synthesis of the graft polymer.

The ink composition of the invention may contain only one specific polymer (c) or a mixture of two or more specific polymers (c). In the ink composition, the content of the specific polymer (c) is preferably 1 to 100 wt %, more preferably 5 to 50 wt %, relative to the content of the pigment.

In the ink composition of the invention, a known pigment dispersant may be used in combination with the specific polymer (c) insofar as the effects of the invention are retained. The amount of the pigment dispersant to be added is preferably 50 wt % or less relative to the amount of the specific polymer (c).

Polymerizable Compound (a)

The curable ink composition of the invention contains the polymerizable compound (a). The polymerizable compound (a) used in the invention is not particularly limited insofar as it undergoes polymerization reaction upon application of some energy to cure. The polymerizable compound (c) may be a monomer, an oligomer, or a polymer. A wide variety of polymerizable monomers known as photocation-polymerizable monomers and photoradical-polymerizable monomers, which initiate polymerization reaction by an initiator species generated from an optionally-added photopolymerization initiator (d), are preferable.

For the purpose of the adjustment of the reaction rate, the physical properties of the ink, and the physical properties of the cured film, only one radical polymerizable compound (a) may be used, or a mixture of two or more radical polymerizable compounds (a) may be used. The polymerizable compound (a) may be a monofunctional or multifunctional compound.

Examples of cation-polymerizable monomers usable as the polymerizable compound (a) include the epoxy compounds, vinyl ether compounds, and oxetane compounds described in JP-A No. 6-9714, JP-A No. 2001-31892, JP-A No. 2001-40068, JP-A No. 2001-55507, JP-A No. 2001-310938, JP-A No. 2001-310937 and JP-A No. 2001-220526.

Examples of the epoxy compounds include aromatic epoxides and aliphatic epoxides.

Examples of monofunctional epoxy compounds usable in the invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butylene monoxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Examples of multifunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxycyclohexyl methyl-3′,4′-epoxycyclohexane carboxylate, 2-(3,4-epoxycyclohexyl-5,5-spiro-3,4-epoxy)cyclohexane-metha-dioxane, bis(3,4-epoxycyclohexylmethyl)adipate, vinylcyclohexene oxide, 4-vinylepoxycyclohexane, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicylopentadiene diepoxide, ethyleneglycol di(3,4-epoxycyclohexylmethyl)ether, ethylenebis(3,4-epoxycyclohexane carboxylate), dioctyl epoxyhexahydrophthalate, di-2-ethylhexyl epoxyhexahydrophthalate, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ether, 1,1,3-tetradecadiene dioxide, limonene dioxide, 1,2,7,8-diepoxy octane, and 1,2,5,6-diepoxy cyclooctane.

Among these epoxy compounds, aromatic epoxides and alicyclic epoxides are preferable since they are advantageous in respect of the curing rate. Alicyclic epoxides are particularly preferable.

Examples of monofunctional vinyl ethers usable in the invention include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexyl methyl vinyl ether, 4-methylhexylmethyl vinyl ether, benzyl vinyl ether, dicyclopentenyl vinyl ether, 2-dicyclopentenoxy ethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxy polyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethyl cyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxy polyethylene glycol vinyl ether.

Examples of multifunctional vinyl ethers include: divinyl ethers such as ethylene glycol divinyl ether, diethylene glycol divinyl ether, polyethylene glycol divinyl ether, propylene glycol divinyl ether, butylene glycol divinyl ether, hexane diol divinyl ether, bisphenol A alkylene oxide divinyl ether, and bisphenol F alkylene oxide divinyl ether; and multifunctional vinyl ethers such as trimethylolethane trivinyl ether, trimethylolpropane trivinyl ether, ditrimethylolpropane tetravinyl ether, glycerin trivinyl ether, pentaerythritol tetravinyl ether, dipentaerythritol pentavinyl ether, dipentaerythritol hexavinyl ether, ethylene oxide-added trimethylolpropane trivinyl ether, propylene oxide-added trimethylolpropane trivinyl ether, ethylene oxide-added ditrimethylolpropane tetravinyl ether, propylene oxide-added ditrimethylolpropane tetravinyl ether, ethylene oxide-added pentaerythritol tetravinyl ether, propylene oxide-added pentaerythritol tetravinyl ether, ethylene oxide-added dipentaerythritol hexavinyl ether, and propylene oxide-added dipentaerythritol hexavinyl ether.

From the viewpoint of curing properties, adhesion to a recording medium, and the surface hardness of an image formed, the vinyl ether compound is preferably a di- or trivinyl ether compound, particularly preferably a divinyl ether compound.

The oxetane compound usable in the invention refers to a compound having an oxetane ring. Such an oxetane compound may be selected arbitrarily from known oxetane compounds such as described in JP-A No. 2001-220526, JP-A No. 2001-310937, and JP-A No. 2003-341217.

The compound having an oxetane ring usable in the ink composition of the invention is preferably a compound having 1 to 4 oxetane rings in its structure. By using such a compound, the viscosity of the ink composition can be maintained in a range which enables easy handling, and the ink after curing adheres strongly to the recording medium.

Examples of monofunctional oxetanes usable in the invention include 3-ethyl-3-hydroxymethyl oxetane, 3-(meth)allyloxymethyl-3-ethyl oxetane, (3-ethyl-3-oxetanylmethoxy)methyl benzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobornyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanylmethyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, and bornyl(3-ethyl-3-oxetanylmethyl)ether.

Examples of multifunctional oxetanes include 3,7-bis(3-oxetanyl)-5-oxa-nonane, 3,3′-(1,3-(2-methylenyl)propanediylbis(oxymethylene))bis-(3′-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, EO-modified bisphenol A bis(3-ethyl-3-oxetanylmethyl)ether, PO-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, and EO-modified bisphenol F (3-ethyl-3-oxetanylmethyl)ether.

Such compounds having oxetane rings are described in detail in columns [0021] to [0084] of JP-A 2003-341217 supra, and the compounds described therein can be preferably used in the present invention as well.

Among the oxetane compounds, a compound having one or two oxetane rings is preferable from the viewpoint of the viscosity and adhesiveness of the ink composition.

In the ink composition of the invention, only one polymerizable compound may be used, or two or more polymerizable compounds may be used. From the viewpoint of effective suppression of shrinkage upon curing, it is preferable to use a combination of at least one oxetane compound and at least one compound selected from epoxy compounds and vinyl ether compounds.

In the invention, the polymerizable compound (a) may be selected from a wide variety of known radical polymerizable monomers that undergo polymerization reaction in the presence of an initiator species generated from a photo-radical initiator.

Examples of such radical polymerizable monomers include (meth)acrylates, (meth)acrylamides, and aromatic vinyls. In the specification, the term “(meth)acrylate” is occasionally used to mean “acrylate” and/or “methacrylate”, and the term “(meth)acryl” is occasionally used to mean “acryl” and/or “methacryl”.

Examples of (meth)acrylates usable in the invention include the followings.

Examples of monofunctional (meth)acrylates include hexyl(meth)acrylate, 2-ethylhexyl(meth)acrylate, tert-octyl(meth)acrylate, isoamyl(meth)acrylate, decyl(meth)acrylate, isodecyl(meth)acrylate, stearyl(meth)acrylate, isostearyl(meth)acrylate, cyclohexyl(meth)acrylate, 4-n-butylcyclohexyl(meth)acrylate, bornyl(meth)acrylate, isobornyl(meth)acrylate, benzyl(meth)acrylate, 2-ethylhexyldiglycol(meth)acrylate, butoxyethyl(meth)acrylate, 2-chloroethyl(meth)acrylate, 4-bromobutyl(meth)acrylate, cyanoethyl(meth)acrylate, benzyl(meth)acrylate, butoxymethyl(meth)acrylate, 3-methoxybutyl(meth)acrylate, alkoxymethyl(meth)acrylate, alkoxyethyl(meth)acrylate, 2-(2-methoxyethoxy)ethyl(meth)acrylate, 2-(2-butoxyethoxy)ethyl(meth)acrylate, 2,2,2-tetrafluoroethyl(meth)acrylate, 1H,1H,2H,2H-perfluorodecyl(meth)acrylate, 4-butylphenyl(meth)acrylate, phenyl(meth)acrylate, 2,4,5-tetramethylphenyl(meth)acrylate, 4-chlorophenyl(meth)acrylate, phenoxymethyl(meth)acrylate, phenoxyethyl(meth)acrylate, glycidyl(meth)acrylate, glycidyloxybutyl(meth)acrylate, glycidyloxyethyl(meth)acrylate, glycidyloxypropyl(meth)acrylate, tetrahydrofurfuryl(meth)acrylate, hydroxyalkyl(meth)acrylate, 2-hydroxyethyl(meth)acrylate, 3-hydroxypropyl(meth)acrylate, 2-hydroxypropyl(meth)acrylate, 2-hydroxybutyl(meth)acrylate, 4-hydroxybutyl(meth)acrylate, 3-hydroxypropyl(meth)acrylate, dimethylaminoethyl(meth)acrylate, diethylaminoethyl(meth)acrylate, dimethylaminopropyl(meth)acrylate, diethylaminopropyl(meth)acrylate, trimethoxysilylpropyl(meth)acrylate, trimethylsilylpropyl(meth)acrylate, polyethylene oxide monomethyl ether(meth)acrylate, oligoethylene oxide monomethyl ether(meth)acrylate, polyethylene oxide(meth)acrylate, oligoethylene oxide(meth)acrylate, oligoethylene oxide monoalkyl ether(meth)acrylate, polyethylene oxide monoalkyl ether(meth)acrylate, dipropylene glycol(meth)acrylate, polypropylene oxide monoalkyl ether(meth)acrylate, oligopropylene oxide monoalkyl ether(meth)acrylate, 2-methacryloyloxytylsuccinic acid, 2-methacryloyloxyhexahydrophthalic acid, 2-methacryloyloxyethyl-2-hydroxypropyl phthalate, butoxyethylene glycol(meth)acrylate, trifluoroethyl(meth)acrylate, perfluorooctylethyl(meth)acrylate, 2-hydroxy-3-phenoxypropyl(meth)acrylate, EO-modified phenol(meth)acrylate, EO-modified cresol(meth)acrylate, EO-modified nonyl phenol(meth)acrylate, PO-modified nonyl phenol(meth)acrylate, and EO-modified 2-ethylhexyl(meth)acrylate.

Examples of bifunctional (meth)acrylates include 1,6-hexanediol di(meth)acrylate, 1,10-decanediol di(meth)acrylate, neopentyl glycol di(meth)acrylate, 2,4-dimethyl-1,5-pentanediol di(meth)acrylate, butylethylpropanediol(meth)acrylate, ethoxylated cyclohexane methanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, hydroxypivalic acid neopentyl glycol di(meth)acrylate, EO-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate, and tricyclodecane di(meth)acrylate.

Examples of trifunctional (meth)acrylates include trimethylolpropane tri(meth)acrylate, trimethylolethane tri(meth)acrylate, trimethylolpropane alkylene oxide-modified tri(meth)acrylate, pentaerythritol tri(meth)acrylate, dipentaerythritol tri(meth)acrylate, trimethylolpropane tri((meth)acryloyloxypropyl)ether, isocyanuric acid alkylene oxide-modified tri(meth)acrylate, propionic acid dipentaerythritol tri(meth)acrylate, tri((meth)acryloyloxyethyl)isocyanurate, hydroxypival aldehyde-modified dimethylolpropane tri(meth)acrylate, sorbitol tri(meth)acrylate, propoxylated trimethylolpropane tri(meth)acrylate, and ethoxylated glycerin triacrylate.

Examples of tetrafunctional (meth)acrylates include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Examples of pentafunctional (meth)acrylates include sorbitol penta(meth)acrylate and dipentaerythritol penta(meth)acrylate.

Examples of hexafunctional (meth)acrylates include dipentaerythritol hexa(meth)acrylate, sorbitol hexa(meth)acrylate, phosphazene alkylene oxide-modified hexa(meth)acrylate, and caprolactone-modified dipentaerythritol hexa(meth)acrylate.

Examples of (meth)acrylamides usable in the invention include (meth)acrylamide, N-methyl(meth)acrylamide, N-ethyl(meth)acrylamide, N-propyl(meth)acrylamide, N-n-butyl(meth)acrylamide, N-t-butyl(meth)acrylamide, N-butoxymethyl(meth)acrylamide, N-isopropyl(meth)acrylamide, N-methylol(meth)acrylamide, N,N-dimethyl(meth)acrylamide, N,N-diethyl(meth)acrylamide, and (meth)acryloyl morpholine.

Examples of aromatic vinyls usable in the invention include styrene, methyl styrene, dimethyl styrene, trimethyl styrene, ethyl styrene, isopropyl styrene, chloromethyl styrene, methoxy styrene, acetoxy styrene, chlorostyrene, dichlorostyrene, bromostyrene, methyl vinylbenzoate, 3-methyl styrene, 4-methyl styrene, 3-ethyl styrene, 4-ethyl styrene, 3-propyl styrene, 4-propyl styrene, 3-butyl styrene, 4-butyl styrene, 3-hexyl styrene, 4-hexyl styrene, 3-octyl styrene, 4-octyl styrene, 3-(2-ethylhexyl)styrene, 4-(2-ethylhexyl)styrene, allyl styrene, isopropenyl styrene, butenyl styrene, octenyl styrene, 4-t-butoxycarbonyl styrene, 4-methoxy styrene, and 4-t-butoxy styrene.

Examples of the radical polymerizable monomer usable in the invention include vinyl esters [vinyl acetate, vinyl propionate, vinyl versate etc.], allyl esters [allyl acetate etc.], halogen-containing monomers [vinylidene chloride, vinyl chloride etc.], vinyl ethers [methyl vinyl ether, butyl vinyl ether, hexyl vinyl ether, methoxy vinyl ether, 2-ethyl hexyl vinyl ether, methoxyethyl vinyl ether, cyclohexyl vinyl ether, chloroethyl vinyl ether etc.] and vinyl cyanides [(meth)acrylonitrile etc.], and olefins [ethylene, propylene etc.].

Among these, the radical polymerizable monomer in the invention is preferably a (meth)acrylate or a (meth)acrylamide from the viewpoint of the curing rate, and particularly preferably a tetrafunctional or higher-functional (meth)acrylate from the viewpoint of the curing rate. From the viewpoint of the viscosity of the ink composition, it is preferable to use a combination of a multifunctional (meth)acrylate such as described above and a monofunctional or bifunctional (meth)acrylate or (meth)acrylamide.

The content of the polymerizable compound (a) in the ink composition is preferably 50 to 95 wt %, more preferably 60 to 92 wt %, still more preferably 70 to 90 wt %, based on the total solid content of the composition.

Pigment (b)

The ink composition of the invention contains a pigment as an essential component. Owing to the function of the specific polymer (c), pigment having a very small particle diameter can be dispersed uniformly and stably in the ink composition, thus enabling the formation of sharp images excellent in coloring property with the ink composition of the invention.

The pigment used herein is not particularly limited, and may be selected from a wide variety of known pigments and dyes depending on the applications. Because the pigment is contained as a colorant, the images obtained by using the ink composition of the invention are excellent in weather resistance.

The pigment that can be advantageously used as a colorant in the invention is described.

The pigment is not particularly limited, and may be selected from common commercially available organic and inorganic pigments, and resin particles dyed with dyes. Further, commercially available surface-treated pigments are also usable.

Examples of these pigments include the pigments described, for example, in Seijiro Itoh, “Dictionary of Pigments” (2000), W. Herbst and K. Hunger, “Industrial Organic Pigments”, and JP-A Nos. 2002-12607, 2002-188025, 2003-26978, and 2003-342503, the disclosures of which are incorporated herein by reference.

Specific examples of the organic and inorganic pigments for use in the invention include the following. Examples of pigments of yellow color include: monoazo pigments such as C.I. Pigment Yellow 1 (Fast Yellow G, etc.) and C.I. Pigment Yellow 74; disazo pigments such as C.I. Pigment Yellow 12 (Disazo Yellow AAA, etc.) and C.I. Pigment Yellow 17; non-benzidine azo pigments such as C.I. Pigment Yellow 180; azolake pigments such as C.I. Pigment Yellow 100 (tartrazine yellow lake, etc.); condensation azo pigments such as C.I. Pigment Yellow 95 (Condensation Azo Yellow GR, etc.); acidic-dye lake pigments such as C.I. Pigment Yellow 115 (quinoline yellow lake, etc.); basic-dye lake pigments such as C.I. Pigment Yellow 18 (thioflavin lake, etc.); anthraquinone pigments such as fravantrone yellow (Y-24); isoindolinone pigments such as isoindolinone yellow 3RLT (Y-110); quinophtharone pigments such as quinophtharone yellow (Y-138); isoindoline pigments such as isoindoline yellow (Y-139); nitroso pigments such as C.I. Pigment Yellow 153 (nickel nitroso yellow, etc.); and metal-complex-salt azomethine pigments such as C.I. Pigment Yellow 117 (copper azomethine yellow, etc.).

Examples of red or magenta pigments include: monoazo pigments such as C.I. Pigment Red 3 (toluidine red, etc.); disazo pigments such as C.I. Pigment Red 38 (Pyrazolone Red B, etc.); azolake pigments such as C.I. Pigment Red 53:1 (Lake Red C, etc.) and C.I. Pigment Red 57:1 (Brilliant Carmine 6B); condensation azo pigments such as C.I. Pigment Red 144 (Condensation Azo Red BR, etc.); acidic dye lake pigments such as C.I. Pigment Red 174 (Phloxine B Lake, etc.); basic dye lake pigments such as C.I. Pigment Red 81 (Rhodamine 6G′ Lake, etc.); anthraquinone pigments such as C.I. Pigment Red 177 (dianthraquinolyl red, etc.); thioindigo pigments such as C.I. Pigment Red 88 (Thioindigo Bordeaux, etc.); perynone pigments such as C.I. Pigment Red 194 (perynone red, etc.); perylene pigments such as C.I. Pigment Red 149 (perylene scarlet, etc.); quinacridone pigments such as C.I. Pigment Violet 19 (unsubstituted quinacridone) and C.I. Pigment Red 122 (quinacridone magenta, etc.); isoindolinone pigments such as C.I. Pigment Red 180 (Isoindolinone Red 2BLT, etc.); and alizarin lake pigments such as C.I. Pigment Red 83 (madder lake, etc.).

Examples of blue or cyan pigments include disazo pigments such as C.I. Pigment Blue 25 (dianisidine blue, etc.); phthalocyanine pigments such as C.I. pigment blue 15 (phthalocyanine blue, etc.); acidic dye lake pigments such as C.I. pigment blue 24 (peacock blue lake, etc.); basic dye lake pigments such as C.I. Pigment Blue 1 (Victoria Pure Blue BO Lake, etc.); anthraquinone pigments such as C.I. pigment blue 60 (indanthron blue, etc.); and alkali blue pigments such as C.I. Pigment Blue 18 (alkali blue V-5:1).

Examples of green pigments include phthalocyanine pigments such as C.I. Pigment Green 7 (phthalocyanine green) and C.I. Pigment Green 36 (phthalocyanine green); and azo metal complex pigments such as C.I. Pigment Green 8 (nitroso green).

Examples of orange pigments include isoindoline pigments such as C.I. Pigment Orange 66 (isoindoline orange); and anthraquinone pigments such as C.I. Pigment Orange 51 (dichloropyranthron orange).

Examples of black pigments include carbon black, titanium black, and aniline black.

Specific examples of white pigments include basic lead carbonate (2PbCO₃Pb(OH)₂, so-called silver white), zinc oxide (ZnO, so-called zinc white), titanium oxide (TiO₂, so-called titanium white), and strontium titanate (SrTiO₃, so-called titanium strontium white).

Since titanium oxide has a lower specific gravity and a higher refractive index than other white pigments and is more stable chemically or physically, titanium oxide has a greater masking and coloring potential as a pigment, and is further excellent in resistance to acid or alkali and other environmental factors. Thus, the use of titanium oxide as a white pigment is preferable. Of course, other white pigment (including white pigments other than those described above) may be used as necessary.

For dispersing the pigment, dispersing machines such as a ball mill, a sand mill, an attriter, a roll mill, a jet mill, a homogenizer, a paint shaker, a kneader, an agitator, a Henschel mixer, a colloid mill, an ultrasonic wave homogenizer, a pearl mill, and a wet jet mill, may be used.

When the pigment is dispersed, the specific polymer (c) is added.

A synergist suitable for the pigment may be used as a dispersing aid as necessary. The amount of dispersing aid is preferably 1 to 50 parts by weight per 100 parts by weight of the pigment.

In the ink composition, a solvent may be added as the dispersion medium for various components such as pigment, or the polymerizable compound (a), which is a low-molecular-weight component, may be used as a solvent-free dispersion medium. The ink composition according to the invention is preferably free of solvent because the composition is a radiation-curable ink that is cured after applied onto a recording medium. If the solvent remains in the cured ink image, solvent resistance may be deteriorated and a problem of VOC (Volatile Organic Compound) may occur. Thus, the dispersion medium is preferably a polymerizable compound (a), particularly preferably a polymerizable compound having the lowest viscosity, in view of the improvement in the dispersibility and handling property of the ink composition.

A pigment having a smaller diameter is more excellent in coloring properties. Therefore, the average particle diameter of the pigment to be used is preferably in the range of about 0.01 to 0.4 μm, more preferably in the range of 0.02 to 0.2 μm. The maximum particle diameter may be 0.3 to 10 μm, preferably 0.3 to 3 μm; such a maximum particle diameter can be achieved by appropriate selections of the pigment (b), the pigment dispersant (c), the dispersing medium, the dispersion conditions, and the filtration conditions. By controlling the particle diameter, clogging in a head nozzle can be prevented, and the storage stability of ink, the transparency of ink, and the curing sensitivity can be secured. Because the specific polymer (c) excellent in dispersibility and stability is used in the invention, a uniform and stable dispersion can be obtained even when fine pigment particles having a very small particle diameter is used.

The particle diameter of the pigment in the ink composition can be measured by a known measurement method. Specifically, the particle diameter can be measured by a centrifugal-sedimentation light-transmission method, an X-ray transmission method, a laser diffraction/scattering method, or a dynamic light scattering method.

The amount of the pigment in the ink composition may be 1 to 20 wt %, more preferably 2 to 10 wt %, in terms of solid content.

In the ink composition of the invention, various additives may be used additionally depending on the purpose, in addition to the above-described essential components. Hereinafter, these optional components are described.

Photopolymerization Initiator (d)

The ink composition of the invention preferably contains a photopolymerization initiator for radical polymerization or cation polymerization.

The photopolymerization initiator in the invention is a compound that is chemically changed by the action of radiation or by the interaction with the electron excited state of a sensitizing dye, to form at least one of radical, acid, and base.

The photopolymerization initiator may be selected appropriately from initiators having sensitivity to the active ray for irradiation, such as UV ray at 400 to 200 nm, far UV ray, g-line, h-line, i-line, KrF excimer laser light, ArF excimer laser light, electron ray, X-ray, molecular beam, or ion beam.

Specifically, any of common photopolymerization initiators known in the art may be used. Specific examples thereof are described, for example, in Bruce M. Monroe et al., Chemical Revue, 93, 435 (1993); R, S. Davidson, Journal of Photochemistry and biology, A: Chemistry, 73, 81 (1993); J. P. Faussier, “Photoinitiated Polymerization-Theory and Applications”: Rapra Review vol. 9, Report, Rapra Technology (1998); and M. Tsunookaetal., Prog. Polym. Sci., 21, 1 (1996), the disclosures of which are incorporated herein by reference. Many compounds favorably used in chemical-amplification photoresists and for photocationic polymerization are also described in Japanese Research Association for Organic Electronics Materials Ed., “Organic Materials for Imaging” (published by Bun-Shin Shuppan (1993), pp. 187 to 192), the disclosure of which is incorporated herein by reference. The compounds that undergo oxidative or reductive bond cleavage through the interaction with the electronically-excited state of sensitizing dye are also known, and described, for example in F. D. Saeva, Topics in Current Chemistry, 156, 59 (1990); G. G. Maslak, Topics in Current Chemistry, 168, 1 (1993); H. B. Shuster et al., JACS, 112, 6329 (1990); I. D. F. Eaton et al., JACS, 102, 3298 (1980), the disclosures of which are incorporated herein by reference.

Preferable examples of such photopolymerization initiators include (a) aromatic ketones, (b) aromatic onium salt compounds, (c) organic peroxides, (d) hexaarylbiimidazole compounds, (e) ketoxime ester compounds, (f) borate compounds, (g) azinium compounds, (h) metallocene compounds, (i) active ester compounds, 0) and compounds containing a carbon-halogen bond.

Preferable examples of the aromatic ketones (a) include the compounds each having a benzophenone or thioxanthone skeleton described, for example in “Radiation Curing in Polymer Science and Technology” J. P. Fouassier and J. F. Rabek (1993), pp. 77 to 117, the disclosure of which is incorporated herein by reference. More preferable examples of the aromatic ketones (a) include the α-thio benzophenone compounds described in Japanese Patent Application Publication (JP-B) No. 47-6416 (the disclosure of which is incorporated herein by reference); the benzoin ether compounds described in JP-B No. 47-3981 (the disclosure of which is incorporated herein by reference); the α-substituted benzoin compounds described in JP-B No. 47-22326 (the disclosure of which is incorporated herein by reference); the benzoin derivatives described in JP-B No. 47-23664 (the disclosure of which is incorporated herein by reference); the aroyl phosphonic acid esters described in Japanese Patent Application Laid-Open (JP-A) No. 57-30704 (the disclosure of which is incorporated herein by reference); the dialkoxybenzophenones described in JP-B No. 60-26483 (the disclosure of which is incorporated herein by reference); the benzoin ethers described in JP-B No. 60-26403 and JP-A No. 62-81345 (the disclosures of which are incorporated herein by reference); the α-amino benzophenones described in JP-B No. 1-34242, U.S. Pat. No. 4,318,791, and EP Patent No. 0284561A1 (the disclosures of which are incorporated herein by reference); p-di(dimethylaminobenzoyl)benzene described in JP-A No. 2-211452 (the disclosure of which is incorporated herein by reference); the thio-substituted aromatic ketones described in JP-A No. 61-194062 (the disclosure of which is incorporated herein by reference); the acylphosphine sulfides described in JP-B No. 2-9597 (the disclosure of which is incorporated herein by reference); the acylphosphines described in JP-B No. 2-9596 (the disclosure of which is incorporated herein by reference); the thioxanthones described in JP-B No. 63-61950 (the disclosure of which is incorporated herein by reference); and the coumarins described in JP-B No. 59-42864 (the disclosure of which is incorporated herein by reference).

Examples of the aromatic onium salt compounds (b) include aromatic onium salts of the elements in Groups V, VI and VII in the periodic table, specifically, aromatic onium salts of N, P, As, Sb, Bi, O, S, Se, Te, and I. Preferable examples thereof include the iodonium salts described in EP Patent No. 104143, U.S. Pat. No. 4,837,124, and JP-A Nos. 2-150848 and 2-96534 (the disclosures of which are incorporated herein by reference); the sulfonium salts described in EP Patent Nos. 370693, 233567, 297443, 297442, 279210, and 422570 and U.S. Pat. Nos. 3,902,144, 4,933,377, 4,760,013, 4,734,444, and 2,833,827 (the disclosures of which are incorporated herein by reference); diazonium salts (e.g., benzene diazonium salts which may be substituted); diazonium salt resins (e.g., formaldehyde resins of diazodiphenylamine); N-alkoxypyridinium salts (e.g., those described in U.S. Pat. No. 4,743,528, JP-A Nos. 63-138345, 63-142345, and 63-142346, and JP-B No. 46-42363 (the disclosures of which are incorporated herein by reference), and specifically, 1-methoxy-4-phenylpyridinium tetrafluoroborate, etc.); and the compounds described in JP-B Nos. 52-147277, 52-14278, and 52-14279 (the disclosures of which are incorporated herein by reference). The aromatic onium salt compound (b) generates a radical or an acid as an active species.

Examples of the organic peroxides (c) include almost all organic compounds having one or more oxygen-oxygen bonds in the molecule; and preferable examples thereof include peroxide esters such as 3,3′,4,4′-tetra-(t-butylperoxycarbonyl)benzophenone, 3,3′,4,4′-tetra-(t-amylperoxycarbonyl)benzophenone, 3,3′,4,4′-tetra-(t-hexylperoxycarbonyl)benzophenone, 3,3′,4,4′-tetra-(t-octylperoxycarbonyl)benzophenone, 3,3′,4,4′-tetra-(cumylperoxycarbonyl)benzophenone, 3,3′,4,4′-tetra-(p-isopropyl cumylperoxycarbonyl)benzophenone, and di-t-butyl diperoxyisophthalate.

Examples of the hexaarylbiimidazole compounds (d) include the Rofin dimers described in JP-B Nos. 45-37377 and 44-86516, such as 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o-,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o-,o′-dichlorophenyl)-4,4′,5,5′-tetraphenylbiimidazole, 2,2′-bis(o-nitrophenol)-4,4′,5,5′-tetraphenylbiimidazole, 2,2′-bis(o-methylphenyl)-4,4′,5,5′-tetraphenylbiimidazole, and 2,2′-bis(o-trifluorophenyl)-4,4′,5,5′-tetraphenylbiimidazole.

Examples of the ketoxime ester compounds (e) include 3-benzoyloxyiminobutan-2-one, 3-acetoxyiminobutan-2-one, 3-propionyloxyiminobutan-2-one, 2-acetoxyiminopentane-3-one, 2-acetoxyimino-1-phenylpropan-1-one, 2-benzoyloxyimino-1-phenylpropan-1-one, 3-p-toluenesulfonyloxyiminobutan-2-one, and 2-ethoxycarbonyloxyimino-1-phenylpropan-1-one.

Examples of the borate compounds (f) include the compounds described in U.S. Pat. Nos. 3,567,453 and 4,343,891, and EP No. 109,772 and 109,773 (the disclosures of which are incorporated herein by reference).

Examples of the azinium salt compounds (g) include the compounds containing an N—O bond described in JP-A Nos. 63-138345, 63-142345, 63-142346, and 63-143537, and JP-B No. 46-42363, the disclosures of which are incorporated herein by reference.

Examples of the metallocene compounds (h) include the titanocene compounds described in JP-A Nos. 59-152396, 61-151197, 63-41484, 2-249, and 2-4705 (the disclosures of which are incorporated herein by reference) and the iron-allene complexes described in JP-A Nos. 1-304453 and 1-152109 (the disclosures of which are incorporated herein by reference).

Specific examples of the titanocene compounds include di-cyclopentadienyl-Ti-dichloride, dicyclopentadienyl-Ti-bisphenyl, di-cyclopentadienyl-Ti-bis-2,3,4,5,6-pentafluorophen-1-yl, di-cyclopentadienyl-Ti-bis-2,3,5,6-tetrafluorophen-1-yl, di-cyclopentadienyl-Ti-bis-2,4,6-trifluorophen-1-yl, di-cyclopentadienyl-Ti-2,6-difluorophen-1-yl, di-cyclopentadienyl-Ti-bis-2,4-difluorophen-1-yl, di-methylcyclopentadienyl-Ti-bis-2,3,4,5,6-pentafluorophen-1-yl, di-methylcyclopentadienyl-Ti-bis-2,3,5,6-tetrafluorophen-1-yl, di-methylcyclopentadienyl-Ti-bis-2,4-difluorophen-1-yl, bis(cyclopentadienyl)-bis(2,6-difluoro-3-(pyr-1-yl)phenyl)titanium, bis(cyclopentadienyl)-bis[2,6-difluoro-3-(methyl sulfonamide)phenyl]titanium, and bis(cyclopentadienyl)-bis[2,6-difluoro-3-(n-butylbiaroyl-amino)phenyl)titanium.

Examples of the active ester compounds (i) include the nitrobenzylester compounds described in EP Patent Nos. 0290750, 046083, 156153, 271851, and 0388343, U.S. Pat. Nos. 3,901,710 and 4,181,531, and JP-A Nos. 60-198538 and 53-133022 (the disclosures of which are incorporated herein by reference); the iminosulfonate compounds described in EP Patent Nos. 0199672, 84515, 199672, 044115, and 0101122, U.S. Pat. Nos. 4,618,564, 4,371,605 and 4,431,774, and JP-A Nos. 64-18143, 2-245756, and 4-365048 (the disclosures of which are incorporated herein by reference); and the compounds described in JP-B Nos. 62-6223 and 63-14340, and JP-A No. 59-174831 (the disclosure of which is incorporated herein by reference).

Preferable examples of the compounds (j) containing carbon-halogen bonds include the compounds described in Wakabayashi et al., Bull. Chem. Soc, Japan, 42, 2924 (1969) (the disclosure of which is incorporated herein by reference); the compounds described in British Patent 1388492 (the disclosure of which is incorporated herein by reference); the compounds described in JP-A No. 53-133428 (the disclosure of which is incorporated herein by reference); and the compounds described in German Patent 3337024 (the disclosure of which is incorporated herein by reference).

Further examples include the compounds described in F. G Schaefer et al., J. Org. Chem. 29, 1527 (1964) (the disclosure of which is incorporated herein by reference); the compounds described in JP-A No. 62-58241 (the disclosure of which is incorporated herein by reference); the compounds described in JP-A No. 5-281728 (the disclosure of which is incorporated herein by reference); as well as the compounds described in German Patent No. 2641100 (the disclosure of which is incorporated herein by reference); the compounds described in German Patent No. 3333450 (the disclosure of which is incorporated herein by reference); the compounds described in German Patent No. 3021590 (the disclosure of which is incorporated herein by reference); and the compounds described in German Patent No. 3021599 (the disclosure of which is incorporated herein by reference).

Preferable specific examples of the compounds represented by (a) to (j) are shown below:

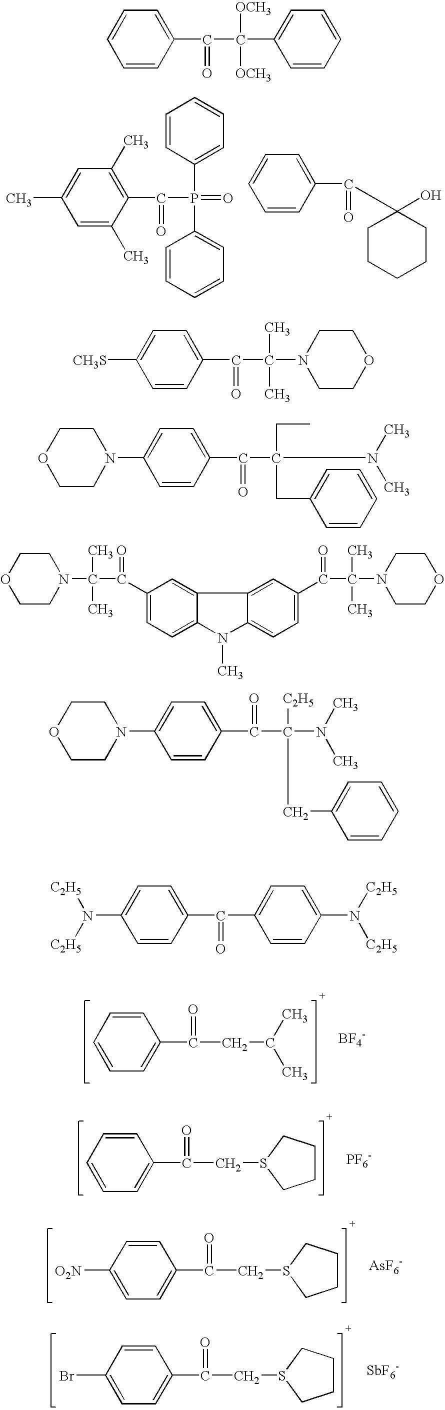

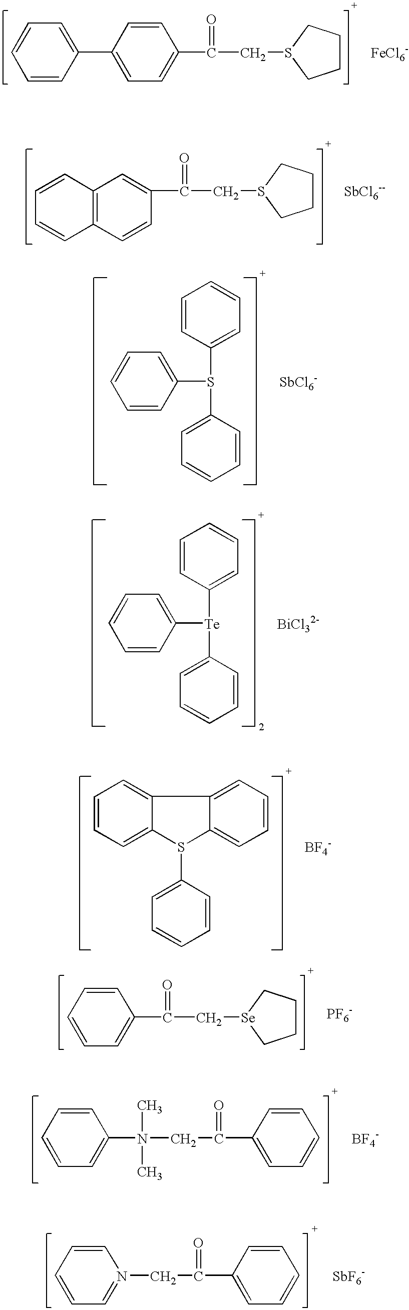

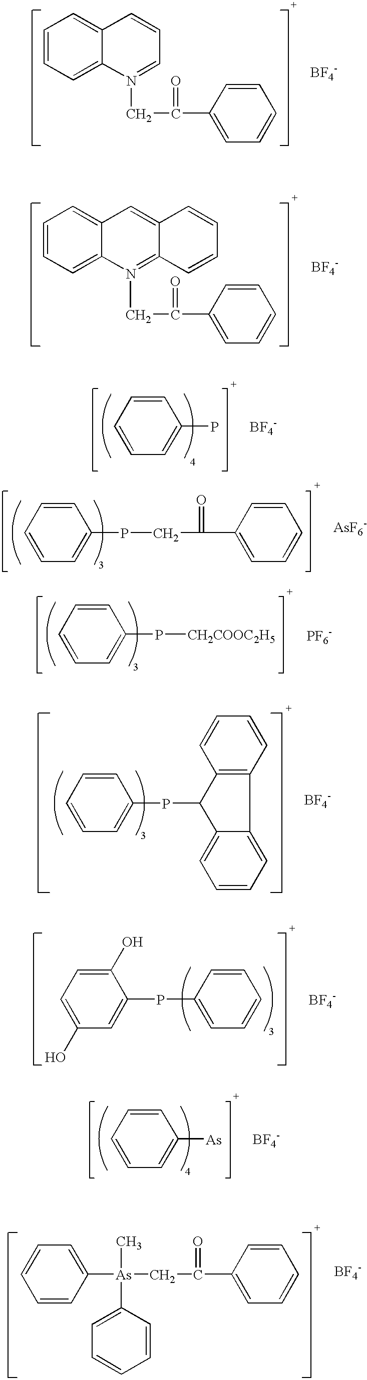

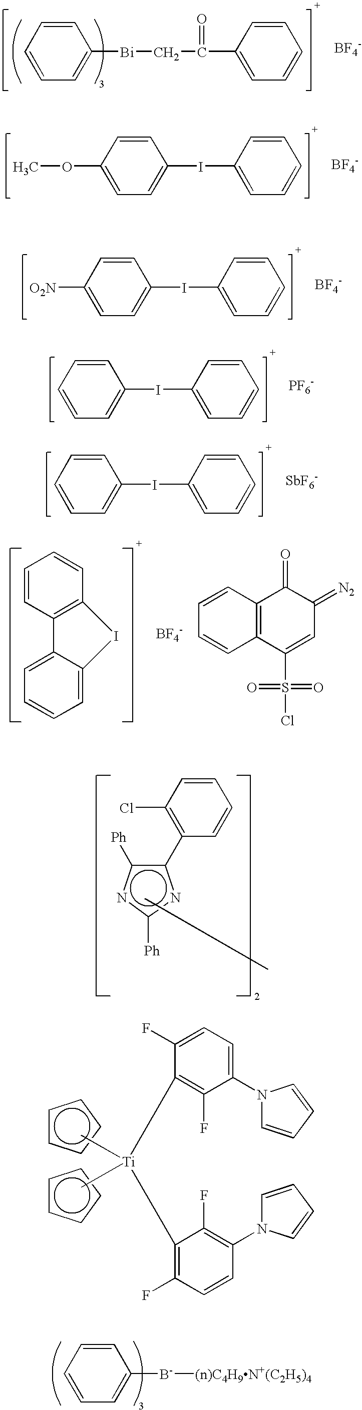

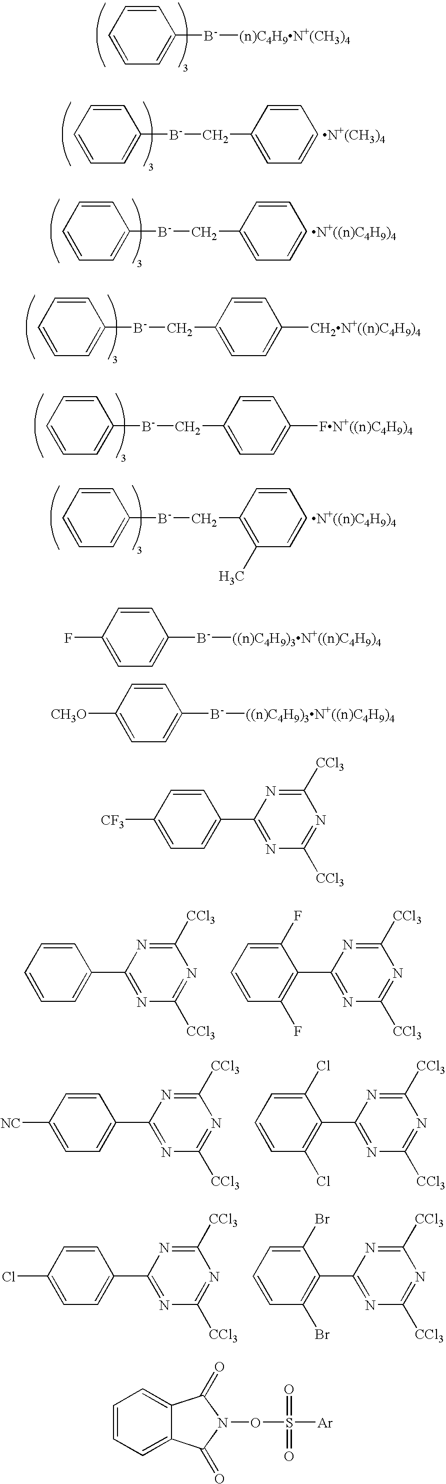

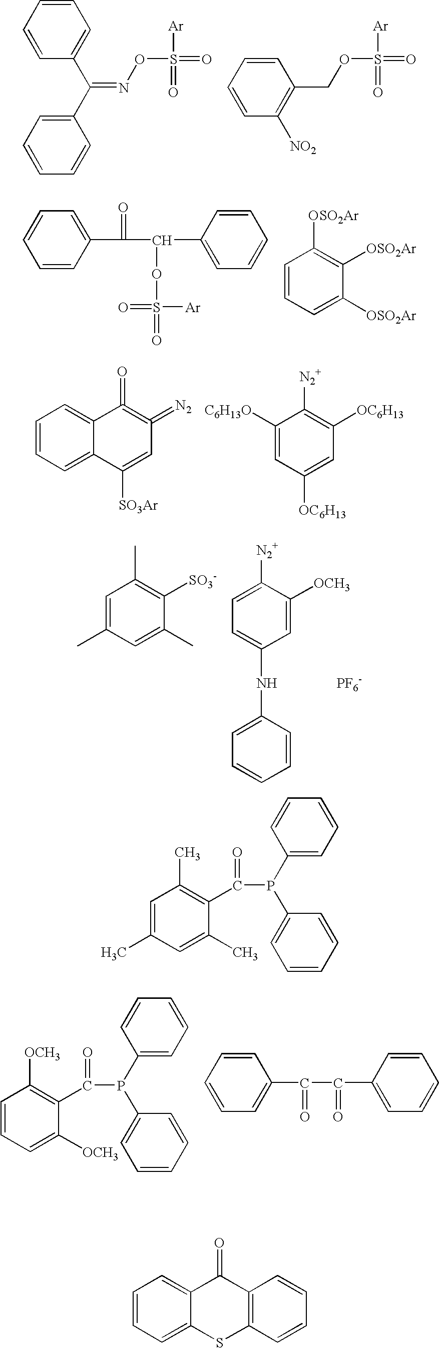

Only one photopolymerization initiator (d) may be used, or two or more photopolymerization initiators (d) may be used in combination. The content of the photopolymerization initiator (d) in the ink composition is preferably 0.1 to 20 wt %, more preferably 0.5 to 10 wt %, still more preferably 1 to 7 wt %, based on the total solid content in the ink composition.

Sensitizing Dye

In the invention, a sensitizing dye may be added for the purpose of improving the sensitivity of the photopolymerization initiator. Preferable examples of the sensitizing dye include those belonging to the following compound classes and having absorption wavelengths in the range of 350 to 450 nm: multinuclear aromatics (e.g., pyrene, perylene, and triphenylene), xanthenes (e.g., fluorescein, eosin, erythrosine, rhodamine B, and Rose Bengal), cyanines (e.g., thiacarbocyanine and oxacarbocyanine), merocyanines (e.g., merocyanine and carbomerocyanine), thiazines (e.g., thionine, methylene blue, and toluidine blue), acridines (e.g., acridine orange, chloroflavin, and acryflavin), anthraquinones (e.g., anthraquinone), squaliums (e.g., squalium), coumarins (e.g., 7-diethylamino-4-methyl coumarin).

More preferable examples of the sensitizing dye include compounds represented by the following formulae (IX) to (XIII):

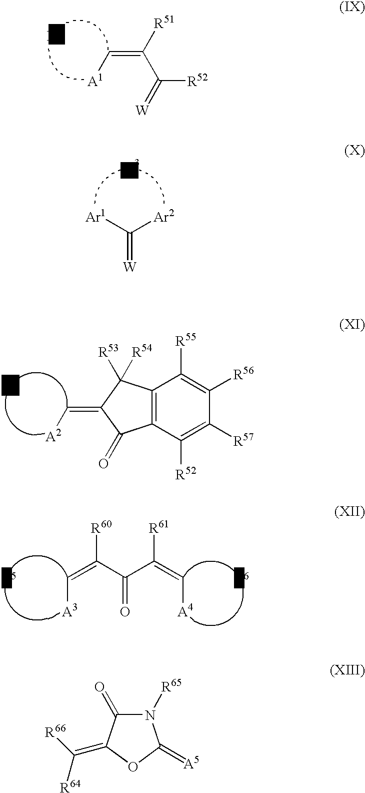

In formula (IX), A¹ represents a sulfur atom or NR⁵⁰, R⁵⁰ represents an alkyl group or an aryl group, L² represents a nonmetallic atomic group which, together with A¹ and the carbon atom adjacent thereto, forms a basic nucleus of a dye, R⁵¹ and R⁵² each independently represent a hydrogen atom or a monovalent nonmetallic atomic group, R⁵¹ and R⁵² may be bound to each other to form an acidic nucleus of a dye, and W represents an oxygen atom or a sulfur atom.

In formula (X), Ar¹ and Ar² each independently represent an aryl group, and are bound to each other via a linkage -L³- which represents —O— or —S—. W has the same definition as in formula (IX).

In formula (XI), A² represents a sulfur atom or NR⁵⁹, L⁴ represents a nonmetallic atomic group which, together with A² and the carbon atom adjacent thereto, forms a basic nucleus of a dye, R⁵³, R⁵⁴, R⁵⁵, R⁵⁶, R⁵⁷ and R⁵⁸ each independently represent a monovalent nonmetallic atomic group, and R⁵⁹ represents an alkyl group or an aryl group.

In formula (XII), A³ and A⁴ each independently represent —S— or —NR⁶² or —NR⁶³—. R⁶² and R⁶³ each independently represent a substituted or unsubstituted alkyl group or a substituted or unsubstituted aryl group. L⁵ represent a nonmetallic atomic group which, together with A³ and the carbon atom adjacent thereto, forms a basic nucleus of a dye. L⁶ represent a nonmetallic atomic group which, together with A⁴ and the carbon atom adjacent thereto, forms a basic nucleus of a dye. R⁶⁰ and R⁶¹ each independently represent a hydrogen atom or a monovalent nonmetallic atomic group, or R⁶⁰ and R⁶¹ are bound to each other to form an aliphatic or aromatic cycle.

In formula (XIII), R⁶⁶ represents an optionally substituted aromatic cycle or heterocycle, A⁵ represents an oxygen atom, a sulfur atom, or —NR⁶⁷—. R⁶⁴, R⁶⁵, and R⁶⁷ each independently represent a hydrogen atom or a monovalent nonmetallic atomic group. R⁶⁷ and R⁶⁴ may be bonded to each other to form an aliphatic or aromatic ring. R⁶⁵ and R⁶⁷ may be bonded to each other to form an aliphatic or aromatic cycle.

Preferable examples of the compounds represented by formulae (IX) to (XIII) include exemplary compounds (A-1) to (A-20) shown below: 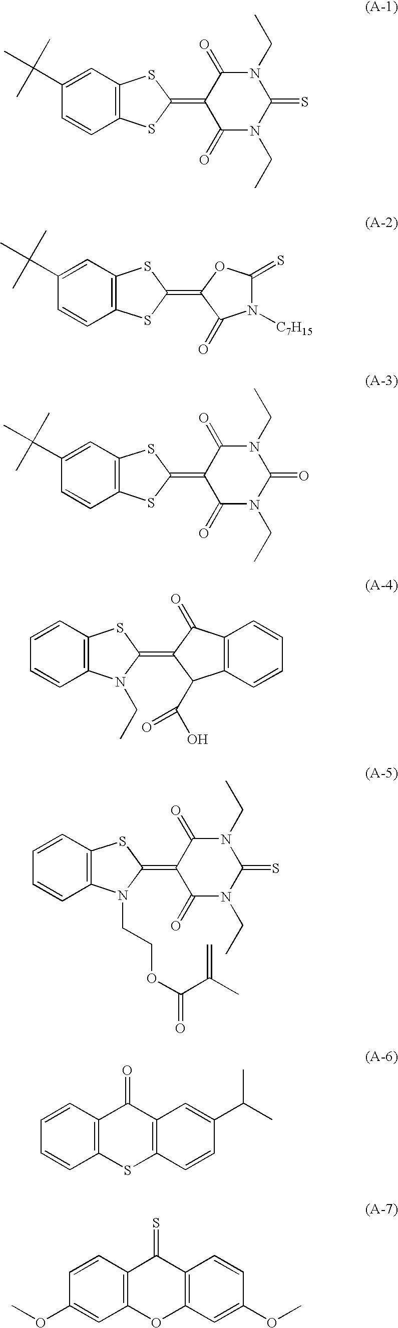 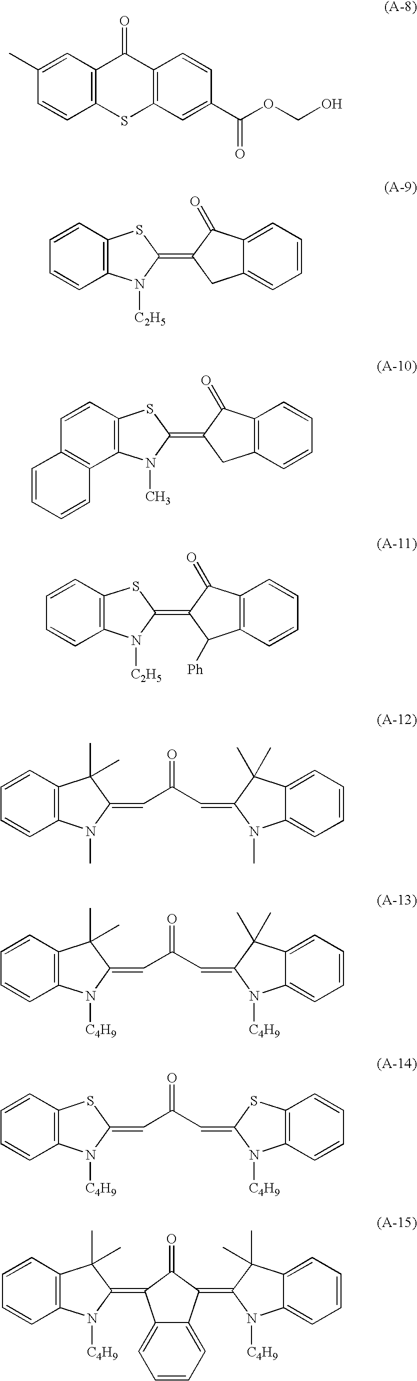 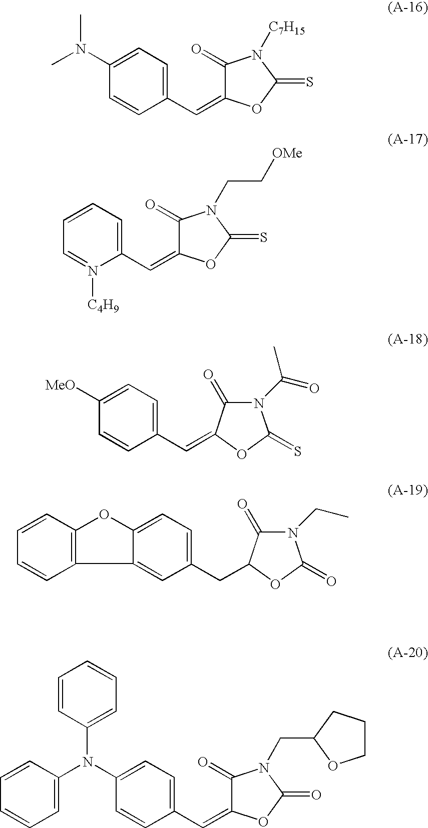
<Cosensitizer>

To the ink composition of the invention, a known compound that has a function of further improving the sensitivity or suppressing the inhibition of polymerization by oxygen may be added as a cosensitizer.

Examples of the cosensitizer include the amines described, for example, in M. R, Sander et al., “Journal of Polymer Society” 10, p. 3173, (1972), JP-B No. 44-20189, JP-A Nos. 51-82102, 52-134692, 59-138205, 60-84305, 62-18537, and 64-33104 and Research Disclosure 33825 (the disclosures of which are incorporated herein by reference); and specific examples thereof include triethanolamine, ethyl p-dimethylaminobenzoate, p-formyldimethylaniline, and p-methylthiodimethylaniline.

Other examples of the cosensitizer include thiols and sulfides, for example, the thiol compounds described in JP-A No. 53-702, JP-B No. 55-500806, and JP-A No. 5-142772 (the disclosures of which are incorporated herein by reference), and the disulfide compounds described in JP-A No. 56-75643 (the disclosure of which is incorporated herein by reference); and specific examples thereof include 2-mercaptobenzothiazole, 2-mercaptobenzoxazole, 2-mercaptobenzimidazole, 2-mercapto-4(3H)-quinazoline, and β-mercaptonaphthalene.

Yet other examples of the cosensitizer include amino acid compounds (e.g., N-phenylglycine), the organic metal compounds described in JP-B No. 48-42965 (e.g., tributyltin acetate), the hydrogen donors described in JP-B No. 55-34414, the sulfur compounds described in JP-A No. 6-308727 (e.g., trithiane), the phosphorus compounds described in JP-A No. 6-250387 (e.g., diethyl phosphite), and the Si—H and Ge—H compounds described in Japanese Patent Application No. 6-191605.

In addition to the essential components (a) to (c), preferable optional component (d), and the sensitizing dye and cosensitizer that can be used together with the component (d), the ink composition according to the invention may further contain various additives in accordance with the purposes. For example, an ultraviolet absorbent may be added to the ink composition according to the invention, for the improvement in the weather fastness of the obtained image and prevention of the discoloration of the image. An antioxidant may be used to improve the stability of the ink composition.

Other usable additives include: an organic or metal-complex-based anti-fading agent; a conductive salt for the control of the ejection properties, such as potassium thiocyanate, lithium nitrate, ammonium thiocyanate, or dimethylamine hydrochloride salt; and a trace amount of an organic solvent for the improvement of the adhesion to the recording medium.

The ink composition according to the invention may further contain a polymer compound selected from various polymer compounds for the purpose of the adjustment of the film physical properties. Examples of polymer compounds include acrylic polymers, polyvinylbutyral resins, polyurethane resins, polyamide resins, polyester resins, epoxy resins, phenol resins, polycarbonate resins, polyvinylbutyral resins, polyvinylformal resins, shellac, vinyl resins, acrylic resins, rubber resin, waxes, and other natural resins. In an embodiment, two or more polymer compounds are used simultaneously.

One or more substances selected from nonionic surfactants, cationic surfactants, and organic fluorocompounds may be added to control the liquid properties.

Other examples of usable additives include leveling additives, matting agents, waxes for controlling the film properties, and tackifiers for improving the adhesion to the recording media such as polyolefin and PET. These additives may be added as necessary.

Considering the ejection efficiency, the ink composition according to the invention preferably has an ink viscosity of 5 to 30 mPa·s, more preferably 7 to 20 mPa·s, at the temperature at the time of ejection. It is preferable to adjust and determine the composition properly so that the viscosity falls in the range. The viscosity at 25 to 30° C. of the ink composition may be 10 to 200 mPa·s, preferably 15 to 100 mPa·s. By increasing the viscosity at room temperature, it become possible to prevent penetration of the ink into the recording medium even when a porous recording medium is used, to reduce the amount of uncured monomer and the odor, to suppress bleeding upon the deposition of ink droplets, and consequently to improve the image quality. An ink viscosity of lower than 10 mPa·s at 25 to 30° C. is not effective in preventing bleeding, while an ink viscosity of more than 200 mPa·s leads to a problem in ink delivery.

The surface tension of the ink composition according to the invention is preferably 20 to 30 mN/m and more preferably 23 to 28 mN/m. When the ink is used for recording on various recording media such as polyolefin, PET, coated paper, and non-coated paper, the surface tension is preferably 20 mN/m or more in view of the prevention of bleeding and penetration, and 30 mN/m or less in view of the wettability.

The ink composition according to the invention thus adjusted is used advantageously as an inkjet recording ink. Specifically, the ink composition according to the invention is ejected onto a recording medium by an inkjet printer, and the deposited ink composition is cured by irradiation with active radiation rays to complete recording.

The printed material obtained using the ink is superior in the strength of the image area which is cured by irradiation with active radiation rays such as ultraviolet rays, and thus can be used not only for image formation with the ink but also for various applications including the formation of an ink-receiving layer (image area) of a planographic printing plate.

Inkjet Recording Method and Inkjet Recording Apparatus

The inkjet recording method according to the invention and the inkjet recording apparatuses to which the recording method is applicable will be described below

In the inkjet recording method, it is preferable to eject the ink composition after the viscosity of ink composition is lowered to 7 to 30 mPa·s by heating to 40 to 80° C., and in this manner, it is possible to realize highly stable ejection. Generally, radiation-curable ink compositions are usually more viscous than aqueous inks, and the fluctuation in the viscosity of radiation-curable ink compositions caused by the fluctuation in temperature during printing is larger. The fluctuation in the viscosity of ink composition exerts significant influences on the droplet size and the droplet ejection speed, causing deterioration in image quality, and thus, it is necessary to keep the temperature of the ink composition as constant as possible during printing. It is preferable to control the ink composition temperature within ±5° C. from the set temperature, more preferably ±2° C. from the set temperature, and still more preferably ±1° C. from the set temperature.

The inkjet recording apparatus may have an ink-temperature stabilizing device. The ink-temperature stabilizing device maintains a constant temperature of the ink composition in all the piping systems and members from the ink tank (from the intermediate tank if such an intermediate tank is present) to the ejection face on the nozzles

The method of controlling the temperature is not particularly limited, and may be, for example, a method in which heating conditions are controlled according to the flow rate of the ink composition and the environmental temperature based on the information supplied from plural temperature sensors provided to the respective pipes. The heat unit to be heated is preferably insulated thermally such that the unit is not affected by the environmental temperature. In a preferable embodiment, the heat unit is thermally insulated form the other portions, and the total heat capacity of the heating unit is small, whereby the printer starting-up time required for heating is shortened and the heat energy loss is reduced.

An active-radiation-curable ink composition can be obtained by adding the photopolymerization initiator (d) to the ink composition of the invention.

Conditions of the irradiation of the ink with active radiation rays will be described below. A basic method of the irradiation with active radiation rays is disclosed in JP-A No. 60-132767, the disclosure of which is incorporated herein by reference. Specifically, light sources are disposed at both side of a head unit that ejects the ink composition, and the ink composition is ejected while the head unit and the light sources are scanned in the shuttle mode. The ink composition is irradiated with the active radiation rays after a predetermined period from the deposition of the ink composition on the recording medium. In an embodiment, the ink composition is cured using another light source that is not driven. Specifically, WO 99/54415 (the disclosure of which is incorporated herein by reference) discloses an irradiation method comprising using an optical fiber and an irradiation method comprising irradiating the recording area (region having the ink composition deposited thereon) with UV rays by directing a collimated rays to a mirror surface on the sidewall of head unit. These irradiation methods may be used in the invention.

Further, in the inkjet recording method according to the invention, it is preferable to heat the ink composition to a predetermined temperature and adjust the period between the deposition of the ink composition on the recording medium and the irradiation with active radiation rays to 0.01 to 0.5 second, preferably 0.01 to 0.3 second, and more preferably 0.01 to 0.15 second. It becomes possible to prevent bleeding of the deposited ink composition before curing, by shortening the period between the deposition of the ink composition on the recording medium and the irradiation of active radiation rays to such an extremely short period. Further, since the ink composition is irradiated before penetrating deep into the recording medium even when the recording medium is porous, the ink composition is surely irradiated, whereby the amount of the remaining unreacted monomer is reduced and consequently the odor is also reduced. The combination of the above-described inkjet recording method and the ink composition of the invention provides a significant synergy effects. In particular when the viscosity of the ink composition at 25° C. is 35 to 500 MP·s, the advantageous effects of the invention are remarkable. By employing such a recording method, it is possible to maintain the dot diameter of the deposited ink composition constant and obtain an image with improved quality, on any of various recording media different in surface wettability. In order to obtain a color image, it is preferable to form images in the order from a color lower in lightness. When an ink of lower lightness is deposited, the active radiation rays are unlikely to reach the inks located at the bottom; therefore, curing sensitivity and improvement in adhesiveness are likely to be deteriorated, and the residual monomer is likely to increased to cause odor. Although it is possible conduct the irradiation with active rays after a full-color image is formed, it is preferable to irradiate the image with active rays after each color ink is deposited, in view of the acceleration of curing.

The inkjet recording apparatus used in the invention is not particularly limited, and a commercial inkjet recording apparatus can be used. In other words, the recording on a recording medium can be conducted by a commercial inkjet recording apparatus.

In the preferable ejecting conditions described above, although the ink composition of the invention is repeatedly heated and cooled, reduction in pigment dispersibility is avoided, excellent coloring property is achieved over a long period, and the deterioration of the ejection property caused by the aggregation of the pigment is also avoided owing to the function of the specific polymer (c) even when the ink composition is stored under such temperature conditions.

(Recording Medium)

The recording medium to which the ink composition according to the invention is applicable is not particularly limited, and examples thereof include ordinary papers such as non-coated paper and coated paper, various non-absorptive resin materials for use in so-called soft packaging, and resin films thereof in the film shape. Examples of such various plastic films include PET film, OPS film, OPP film, ONy film, PVC film, PE film, and TAC film. Examples of other plastics usable as the material of the recording medium include polycarbonate, acrylic resins, ABS, polyacetal, PVA, and rubbers. In addition, metals and glasses are also usable as the recording media.

The printed material according to the invention can be obtained by depositing the ink composition of the invention onto a recording medium with an inkjet printer, and then irradiating the deposited ink composition with active radiation, thus curing the ink composition. Since the ink used for the formation of the image contains fine pigment particles uniformly and stably dispersed therein, the printed material of the invention has a high-quality image excellent in coloring property, sharpness, and weather resistance, thus being applicable to various fields.

### EXAMPLES

Hereinafter, the present invention will be described in more detail by reference to the Examples, but the invention is not limited to these examples.

Synthesis of Specific Polymer (c)

### Synthesis Example 1

15 parts by weight of 1-methoxy-2-propyl acetate was introduced into a three-necked flask previously purged with nitrogen, and then stirred with a stirrer (Three-One-Motor: manufactured by Shinto Kagaku Co., Ltd.) and heated to 78° C. while nitrogen was passed through the flask. The monomer solution and the initiator solution shown below, which had been separately prepared, were simultaneously added thereto dropwise over 2 hours. After the addition was completed, 0.08 part by weight of V-65 was added, and the mixture was heated to 78° C. for 3 hours under stirring. The resultant reaction solution was poured into 1000 parts of hexane while stirred, and the resultant precipitates were heated and dried to give a graft polymer 1.

(Monomer solution)

| | | |
|---|---|---|
| Dimethylaminoethyl acrylate | 4.1 | parts by weight |
| Polymethyl methacrylate having a methacryloyl | 25.9 | parts by weight |
| group at a terminal (number-average | | |
| molecular weight 6000, AA-6; manufactured | | |
| by Toagosei Co., Ltd.) | | |
| 1-Methoxy-2-propyl acetate | 45 | parts by weight |

(Initiator solution)

| | | |
|---|---|---|
| 2,2-Azobis(2,4-dimethyl valeronitrile) | 0.04 | part by weight |
| (manufactured by Wako Pure Chemical | | |
| Industries, Ltd.) | | |
| 1-Methoxy-2-propyl acetate | 9.6 | parts by weight |

### Synthesis Example 2

A graft polymer 2 was obtained in the same manner as in Synthesis Example 1 except that 4.1 parts by weight of dimethylaminoethyl acrylate used in Synthesis Example 1 was changed to 2.1 parts by weight of N-vinylimidazole.

### Synthesis Example 3

A graft polymer 3 was obtained in the same manner as in Synthesis Example 1 except that the monomer solution used in Synthesis Example 1 was changed to the following composition.

(Monomer solution)

| | | |
|---|---|---|
| 3-(N,N-dimethylaminopropylacrylamide) | 4.5 | parts by weight |
| Polymethyl methacrylate having a methacryloyl | 19.5 | parts by weight |
| group at a terminal (number-average | | |
| molecular weight 6000, AA-6: manufactured | | |
| by Toagosei Co., Ltd.) | | |
| Methoxypolyethylene glycol methacrylate | 6.0 | parts by weight |
| (NK Ester M-230G: manufactured by | | |
| Toagosei Co., Ltd.) | | |
| 1-Methoxy-2-propyl acetate | 45 | parts by weight |

### Synthesis Example 4

A graft polymer 4 was obtained in the same manner as in Synthesis Example 1 except that 4.1 parts by weight of dimethylaminoethyl acrylate used in Synthesis Example 1 was replaced with 2.0 parts by weight of styrene and 2.1 parts of t-octyl acrylamide.

### Example 1

The specific polymer (c) shown below was dissolved in the mixture of the polymerizable compounds (a), and introduced, together with the pigment (b), into a motor mill M50 (manufactured by Eiger Co., Ltd.). The mixture was subjected to dispersing treatment for 6 hours at a circumferential speed of 9 m/s with zirconia beads of 0.65 mm in diameter, thus giving a stock solution of an active-radiation-curable ink. Then, the photopolymerization initiator (d) was added to, and gently mixed with, the ink stock solution. The mixture obtained was then filtered under pressure through a membrane filter to give an active-radiation-curable inkjet ink of Example 1.

| | | |
|---|---|---|
| Pigment (b) [phthalocyanine pigment PB15:3] | 5.0 | parts |
| Specific polymer (c) [graft polymer 1 | 2.5 | parts |
| obtained in Synthesis Example 1] | | |
| Polymerizable compound (a) [hexanediol diacrylate] | 60.0 | parts |
| (HDDA: manufactured by Daicel UCB) | | |
| Polymerizable compound (a) [caprolactone-modified | 27.5 | parts |
| dipentaerythritol hexaacrylate, DPCA-60: | | |
| manufactured by NIPPON KAYAKU Co., Ltd.] | | |
| Photopolymerization initiator (d) [acylphosphine | 5.0 | parts |
| oxide compound] (LUCIRIN TPO-L: | | |
| manufactured by BASF)] | | |

### Examples 2 to 4

Active-radiation-curable inkjet inks of Example 2 to 4 were obtained in the same manner as in Example 1 except that the specific pigment dispersant (c) was changed from the graft polymer 1 to the graft polymers 2 to 4, respectively.

### Comparative Example 1

An active-radiation-curable inkjet ink of Comparative Example 1 was obtained in the same manner as in Example 1 except that a commercial pigment dispersant “SORSPERSE 24000GR” (manufactured by Avecia) was used in place of the graft polymer 1 used as the specific polymer (c) in Example 1.

### Comparative Example 2

An active-radiation-curable inkjet ink of Comparative Example 2 was obtained in the same manner as in Example 1 except that a commercial pigment dispersant “SORSPERSE 32000” (manufactured by Avecia) was used in place of the graft polymer 1 used as the specific polymer (c) in Example 1.

### Examples 5 to 8 and Comparative Examples 3 to 4

Inkjet ink compositions of Examples 5 to 8 and Comparative Examples 3 to 4 were obtained in the same manner as in Example 1 to 4 and Comparative Examples 1 to 2 respectively, except that the pigment PB15:3 (b) was changed to PY-120.

### Examples 9 to 12 and Comparative Examples 5 to 6

Inkjet inks of Example 9 to 12 and Comparative Examples 5 to 6 were obtained in the same manner as in Example 1 to 4 and Comparative Examples 1 to 2 respectively, except that the polymerizable compounds (a) and the photopolymerization initiator (d) were changed as shown below:

| | | |
|---|---|---|
| Polymerizable compound (a): oxetane compound | 70.0 | parts |
| (OXT-221, manufactured by Toagosei Co., Ltd.) | | |
| Polymerizable compound (a): epoxy compound | 17.5 | parts |
| (CELLOXIDE 3000: DAICEL CHEMICAL | | |
| INDUSTRIES, Ltd) | | |
| Photopolymerization initiator (d): triphenyl | 5.0 | parts |
| sulfonium salt (ADEKA OPTOMER | | |
| SP-150: manufactured by Asahi Denka Kogyo K.K.) | | |

### Examples 13 to 16 and Comparative Examples 7 to 8

Inkjet inks of Examples 13 to 16 and Comparative Examples 7 to 8 were obtained in the same manner as in Example 9 to 12 and Comparative Examples 5 to 6 respectively, except that the pigment PB15:3 was changed to quinacridone pigment PR122.

Evaluation of Ink Compositions

The inkjet inks obtained were evaluated according to the methods descried below. The results are shown in Table 1.

(1. Viscosity)

The viscosity of each inkjet ink at 25° C. was measured with an E-type viscometer.
A: less than 30 mPas.
B: 30 mPas or more but less than 100 Pas.
C: 100 mPas or more (problematic at ejection).
   (2. Stability)

Each inkjet ink was stored at 25° C. for 1 month or at 70° C. for 24 hours. Then, the dispersion state of the ink was evaluated with the naked eye and by the change in viscosity.
AA: Generation of precipitates was not observed, and viscosity was not increased.
A: Generation of precipitates was not observed. Although the viscosity increased slightly, there is no problem about the ejection property.
B: Generation of precipitates was not observed. However, the viscosity increased to deteriorate the ejection property, thus creating practical problems
C: Generation of precipitates was observed
   (3. Average Particle Diameter)

The volume-based average particle diameter D₅₀ of each inkjet ink was measured with a particle size distribution measuring instrument in light scattering diffraction system (LA910: manufactured by Horiba Ltd.), and was evaluated.
A: D₅₀ is less than 100 nm.
B: D₅₀ is 100 nm or more but less than 200 nm.
C: D₅₀ is 200 nm or more.
   (4. Curing Properties)

Each ink composition was deposited on art paper with an inkjet printer (printing density 300 dpi, ejection frequency 4 kHz, number of nozzles 64) and then exposed to light at 100 mJ/cm² emitted by a Deep UV lamp (SP-7: manufactured by Ushio Inc.), whereby a printed sample was obtained.

The adhesiveness of the cured film was evaluated by touching the film with the fingers. The criteria are as follows:
A: Not sticky.
B: Slightly sticky.
C: Significantly sticky.
   (5. Stability to Heat Cycles)

Each ink composition was subjected to 10 cycles of heating and cooling between 25° C. and 60° C., and then used for printing with the above inkjet printer. The clogging of nozzles was observed and evaluated according to the following criteria.
A: High-quality image was formed without clogging of nozzles.
B: Image defects were observed with the generation of satellites in portions.

C: Image defects were significant owing to the clogging of nozzles.

TABLE 1

| | | Evaluation of ink compositions | | | | | |
|---|---|---|---|---|---|---|---|
| | | | Stability | Stability | Particle | Curing | Stability to |
| | Pigment dispersant | Viscosity | (room temperature) | (70° C.) | diameter | properties | heat cycles |
| Ex. 1 | Graft polymer 1 | A | AA | AA | A | A | A |
| Ex. 2 | Graft polymer 2 | A | AA | AA | A | A | A |
| Ex. 3 | Graft polymer 3 | A | AA | AA | A | A | A |
| Ex. 4 | Graft polymer 4 | A | AA | A | A | A | A |
| Comp. Ex. 1 | Commercial dispersant | A | B | B | A | A | B |
| | (24000GR) | | | | | | |
| Comp. Ex. 2 | Commercial dispersant | A | AA | B | A | A | B |
| | (32000) | | | | | | |
| Ex. 5 | Graft polymer 1 | A | AA | AA | A | A | A |
| Ex. 6 | Graft polymer 2 | A | AA | AA | A | A | A |
| Ex. 7 | Graft polymer 3 | A | AA | AA | A | A | A |
| Ex. 8 | Graft polymer 4 | A | AA | A | B | A | A |
| Comp. Ex. 3 | Commercial dispersant | C | B | C | C | A | C |
| | (24000GR) | | | | | | |
| Comp. Ex. 4 | Commercial dispersant | B | B | B | B | A | C |
| | (32000) | | | | | | |
| Ex. 9 | Graft polymer 1 | A | AA | AA | A | A | A |
| Ex. 10 | Graft polymer 2 | A | AA | AA | A | A | A |
| Ex. 11 | Graft polymer 3 | A | AA | AA | A | A | A |
| Ex. 12 | Graft polymer 4 | A | AA | A | A | A | A |
| Comp. Ex. 5 | Commercial dispersant | A | B | B | A | A | B |
| | (24000GR) | | | | | | |
| Comp. Ex. 6 | Commercial dispersant | A | A | B | A | A | B |
| | (32000) | | | | | | |
| Ex. 13 | Graft polymer 1 | A | AA | AA | A | A | A |
| Ex. 14 | Graft polymer 2 | A | AA | AA | A | A | A |
| Ex. 15 | Graft polymer 3 | A | AA | AA | A | A | A |
| Ex. 16 | Graft polymer 4 | B | AA | A | A | A | A |
| Comp. Ex. 7 | Commercial dispersant | C | B | C | C | A | B |
| | (24000GR) | | | | | | |
| Comp. Ex. 8 | Commercial dispersant | B | A | C | B | A | B |
| | (32000) | | | | | | |

As is clear from Table 1, the ink compositions of the invention cured with high sensitivity upon irradiation with radiation and formed non-adhesive high-quality images. The ink compositions of the invention were excellent in both pigment dispersibility and dispersion stability, and thickening caused by lowered pigment dispersibility was not observed even when stored for long period or stored under conditions of repeated temperature changes.

On the other hand, the comparative examples using the commercial polymer dispersants showed excellent pigment dispersibility at first, but they were not stable when stored at a high temperature or when underwent heat cycles; thus, they had practical problems.

According to the invention, an ink composition is provided which is favorable for inkjet recording, excellent in dispersibility and stability of the fine pigment particles, and capable of forming a high-quality image with clear tone and high tinting strength, and which can be cured by irradiation with active radiation. An inkjet recording method using the ink composition is also provided.

The printed matter of the invention has thereon a high-quality image obtained by using the ink composition which is curable by irradiation with active radiation and which has clear tone and high tinting strength.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink composition comprising (a) a polymerizable compound, (b) a pigment, and (c) a graft polymer containing, as a polymerization unit, a polymerizable oligomer having an ethylenically unsaturated double bond at least at a terminal thereof.

2. The ink composition according to claim 1, wherein the polymerizable oligomer is an oligomer having a (meth)acryloyl group at a terminal thereof.

3. The ink composition according to claim 1, wherein the polymerizable oligomer is an oligomer having a number-average molecular weight of 1000 to 20000.

4. The ink composition according to claim 1, wherein the polymerizable oligomer is a homopolymer or copolymer of at least one monomer selected from the group consisting of alkyl(meth)acrylates, styrenes, acrylonitril, vinyl acetate, and butadiene.

5. The ink composition according to claim 1, wherein the polymerizable oligomer is a homopolymer or copolymer of at least one monomer selected from the group consisting of alkyl(meth)acrylates and styrenes.

6. The ink composition according to claim 1, wherein the polymerizable oligomer is a polymer in which a (meth)acryloyl group is bound to one terminal of polystyrene, polymethyl(meth)acrylate, poly-n-butyl(meth)acrylate, or poly-i-butyl(meth)acrylate.

7. The ink composition according to claim 1, wherein the polymerizable oligomer is represented by formula (1): 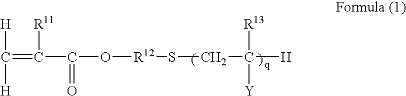
wherein in formula (1), R¹¹ and R¹³ each independently represent a hydrogen atom or a methyl group; R¹² represents a C1 to C12 alkylene group which may have a substituent and may have an ester bond, an ether bond, or an amide bond at a terminal; Y represents a phenyl group, a phenyl group having a C1 to C4 alkyl group, or —COOR¹⁴ in which R¹⁴ represents a C1 to C6 alkyl group, a phenyl group, or a C7 to C10 aryl alkyl group; and q represents 20 to 200.

8. The ink composition according to claim 1, wherein the graft polymer further contains, as a polymerization unit, a monomer having a nitrogen-containing group and an ethylenically unsaturated double bond.

9. The ink composition according to claim 8, wherein the monomer having a nitrogen-containing group and an ethylenically unsaturated double bond is represented by formula (I): 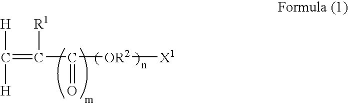
wherein in formula (I), R¹ represents a hydrogen atom or a methyl group; R² represents a C1 to C12 alkylene group; X¹ represents —N(R³)(R⁴), —R⁵—N(R⁶)(R⁷), or a basic nitrogen-containing heterocyclic group; R³, R⁴, R⁶ and R⁷ each independently represent a hydrogen atom, a C1 to C18 alkyl group, or a C6 to C18 aryl group; R⁵ represents a C1 to C12 alkylene group; and m and n each independently represent 1 or 0.

10. The ink composition according to claim 9, wherein X¹ represents a a pyridyl group, a piperidino group, a pyrrolidyl group, a pyrrolidino group, an imidazolino group, or a morpholino group.

11. The ink composition according to claim 1, further comprising (d) a photopolymerization initiator.

12. The ink composition according to claim 11, wherein the polymerizable compound (a) is a radical-polymerizable compound, and the photopolymerization initiator (d) is a photoradical generator.

13. The ink composition according to claim 11, wherein the polymerizable compound (a) is a cation-polymerizable compound, and the photopolymerization initiator (d) is a photoacid generator.

14. The ink composition according to claim 1, wherein an amount of the polymerizable oligomer in the graft polymer is 20 to 99% by weight.

15. The ink composition according to claim 8, wherein an amount of the monomer having a nitrogen-containing group and an ethylenically unsaturated double bond in the graft polymer is 20 to 99% by weight.

16. An inkjet ink composition comprising the ink composition of claim 1.

17. An inkjet recording method comprising:
depositing the ink composition of claim 16 onto a recording medium with an inkjet printer; and
curing the deposited ink composition by irradiation with active radiation.

18. A printed material produced by a method comprising:
depositing the ink composition of claim 16 on a recording medium with an inkjet printer; and
curing the ink composition by irradiation with active radiation.
